(19) United States
(12) Patent Application Publication
(10) Pub. No.: US 2005/0256727 A1
(43) Pub. Date: Nov. 17, 2005

(54) Method and system for validating a client

(75) Inventors: Brett R. Bennett, Seattle, WA (US); Robert Silten, Branford, CT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Expediters International of Washington Inc., Seattle, WA (US)

(21) Appl. No.: 10/845,491

(22) Filed: May 13, 2004

(51) Int. Cl. G06F 17/60

(52) U.S. Cl. 705/1

(57) ABSTRACT

A system and method for collecting, analyzing, and managing information for a plurality of clients within a supply-chain is provided. According to one aspect, a management processing system generates a questionnaire management interface for obtaining information for a particular client, including client address, client contact information, and threat categories associated with that client. In response to obtaining the information, the management processing system generates a set of baseline questions representative of the identified threat categories and a set of custom questions that have been associated with that client.

### FIELD OF THE INVENTION

In general, the present invention relates to computer networks and software, and in particular, to a system and method for the collection, analysis, and management of client data and client validation, in a multi-tiered environment.

### BACKGROUND OF THE INVENTION

Generally described, transactions, such as international commerce transactions, can involve the execution of a number of steps by a number of parties to complete one or more transactions. In an example international transaction, an importer may request materials from a supplier. That supplier, in order to provide the materials to the importer, may need to obtain materials from two other suppliers, who themselves may obtain some of the material from still other suppliers. This chain of importer-supplier-supplier is referred to herein as a “supply-chain.” A supply-chain may be any combination of importers and suppliers. For example, a supply-chain may consist of one importer and one supplier, one importer and multiple suppliers, those suppliers providing materials directly to the importer and obtaining materials from other suppliers within the supply-chain.

With the increase in competition, the threat of terrorism, and the desire for increased border security, it has become desirable for companies to ensure that those operating within its supply-chain maintain good business practices, comply with trade laws, and comply with the companies' own internal regulations and standards. However, existing approaches for ensuring the integrity of a supply-chain and maintaining supply-chain information are inefficient and do not ensure compliance from suppliers. Additionally, for a supply-chain having multiple suppliers, many of which are obtaining materials from still other suppliers, it is difficult to monitor and, in some instances, even be aware of, all suppliers within the entire supply-chain.

One approach to mitigate the problems associated with supply-chain integrity and monitoring includes the use of standard questionnaires that are generated and mailed out to suppliers within a chain for completion and return. Although traditional mail-based questionnaires can assist in obtaining a limited amount of information for companies within a supply-chain, the traditional mail-based questionnaires can be deficient for a variety of reasons. In one aspect, the traditional mail-based questionnaires do not allow for the management and generation of custom questionnaires for suppliers within the supply-chain. Additionally, there are no efficient means for monitoring whether those questionnaires have been completed and returned by each of the suppliers and, for those that have been returned, it is difficult and time consuming to evaluate the responses. For example, if an importer mails out questionnaires to each of its suppliers and three-fourths of those questionnaires are returned, the non-responding parties must be manually identified and contacted. Additionally, for those suppliers which have responded, if the responses are to be evaluated and compared, each questionnaire must be manually reviewed and reports must be manually generated. This approach increases the time required to review information about parties within a supply-chain and becomes more difficult as the size of the supply-chain increases.

In another aspect, it may be difficult for an importer to locate and issue questionnaires to all of the suppliers within its supply chain. While an importer is generally able to identify suppliers with which it directly conducts business, it is often difficult for the importer to identify suppliers farther down the supply-chain. Thus, while the importer may be able to validate the integrity of its direct suppliers through standard questionnaires, it is difficult to validate the suppliers farther down in the supply-chain. Thus, it is currently difficult for a supplier to validate the integrity of its supply-chain beyond its direct suppliers.

In yet another aspect, suppliers may be overburdened with questionnaires from multiple parties. Currently, for each importer and/or supplier for which a supplier provides materials or otherwise conducts business, it may receive similar questionnaires from each of the individual importers and/or suppliers. Many of those multiple questionnaires may contain similar, if not the same, questions. For a supplier who services multiple parties, the process of completing and returning each questionnaire can become an extremely time consuming task. However, if the supplier fails to complete a questionnaire, it may be designated as a non-complying supplier and removed from that supply-chain, thereby losing business.

Based on the above-described deficiencies associated with the conventional art, there exists a need for a system and method for the efficient collection, analysis, and management of supply-chain data, and for the validation of parties within a supply-chain.

### SUMMARY OF THE INVENTION

A system and method for collecting, analyzing, and managing information for a plurality of clients within a supply-chain and for validating clients within a supply-chain is provided. According to one aspect, a management processing system generates a questionnaire management interface for obtaining information for a particular client, including client address, client contact information, and threat categories associated with that client. In response to obtaining the information, the management processing system generates a set of baseline questions representative of the identified threat categories and a set of custom questions that have been associated with that client.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a representative portion of the Internet;

FIG. 2 is a block diagram of a supply-chain management processing system including a number of importer computing devices, a number of supplier computing devices, a management processing system, and a management database formed in accordance with an embodiment of the present invention;

FIG. 3 is a block diagram illustrating a three-tier supply-chain;

FIG. 4 is a block diagram depicting an illustrative architecture for an importer computing device and a supplier computing device, in accordance with an embodiment of the present invention;

FIG. 5 is a block diagram depicting an illustrative architecture for a management processing system, in accordance with an embodiment of the present invention;

FIG. 6 is a block diagram depicting a threat matrix illustrating the relationship between client categories and threat categories, in accordance with an embodiment of the present invention;

FIGS. 7, 8, 9, 10, 11, and 12 are flow diagrams illustrative of a supply-chain processing system and the interaction between two client importers utilizing the supply-chain processing system, and a management processing system, according to an embodiment of the present invention;

FIGS. 13A and 13B are block diagrams illustrative of a screen display for allowing a client to provide specifics about itself, including the identification of its suppliers, according to an embodiment of the present invention;

FIG. 14 is a block diagram illustrative of a screen display for allowing a client to provide responses to baseline questions representative of its identified threat categories, in accordance with an embodiment of the present invention;

FIG. 15 is a block diagram illustrative of a question management screen display of a questionnaire management interface, in accordance with an embodiment of the present invention;

FIGS. 16 and 17 are block diagrams illustrative of a question revision screen display of a questionnaire management interface, in accordance with an embodiment of the present invention;

FIG. 18 illustrates a block diagram of a template management screen display of a questionnaire management interface, in accordance with an embodiment of the present invention;

FIG. 19 illustrates a block diagram of a template management screen display of a questionnaire management interface, in accordance with an embodiment of the present invention;

FIG. 20 illustrates a block diagram of a questionnaire assignment screen display of a questionnaire management interface, in accordance with an embodiment of the present invention;

FIG. 21 illustrates a block diagram of a second questionnaire assignment screen display of a questionnaire management interface, in accordance with an embodiment of the present invention;

FIGS. 22 and 23 illustrate block diagrams of a second portion of a supply-chain processing system depicting a client supplier in communication with a management processing system, in accordance with an embodiment of the present invention;

FIG. 24 illustrates a custom questionnaire screen display generated by a management processing system, in accordance with an embodiment of the present invention;

FIG. 25 illustrates a block diagram of an importer review screen display, in accordance with an embodiment of the present invention;

FIG. 26 illustrates a block diagram with a portion of a supply-chain processing system and the interaction between a client importer and the management processing system, in accordance with an embodiment of the present invention;

FIG. 27 illustrates a block diagram of a screen display of a supplier review questionnaire, in accordance with an embodiment of the present invention;

FIG. 28 illustrates a block diagram of a screen display of a completed questionnaire, in accordance with an embodiment of the present invention;

FIG. 29 is a block diagram of a solicitation screen display of a questionnaire management interface for viewing suppliers' responses to issued questionnaires, in accordance with an embodiment of the present invention;

FIG. 30 illustrates a block diagram of a filter screen display of a questionnaire management interface generated by a management processing system for allowing a client to view filtered information, in accordance with an embodiment of the present invention;

FIG. 31 illustrates a status report screen display of a questionnaire management interface generated by a management processing system, in accordance with an embodiment of the present invention;

FIG. 32 illustrates a supplier compliance report screen display of a questionnaire management interface generated by the management processing system, in accordance with an embodiment of the present invention;

FIG. 33 illustrates a category weighting screen display of a questionnaire management interface that may be utilized for weighting groups and questions by threat category, in accordance with an embodiment of the present invention;

FIG. 34 is a block diagram of a screen display illustrating the results of an extraction routine, which may be accomplished utilizing a questionnaire management interface generated by the management processing system, in accordance with an embodiment of the present invention;

FIG. 35 is a flow diagram of a client management routine, in accordance with an embodiment of the present invention;

FIG. 36 is a flow diagram of the different features available in a questionnaire management interface generated by the management processing system, in accordance with an embodiment of the present invention;

FIG. 37 is a flow diagram of the question management routine of a questionnaire management interface for allowing an importer to manage questions, in accordance with an embodiment of the present invention;

FIG. 38 is a flow diagram of a template management routine performed by the management processing system for allowing an accessing importer to manage templates, in accordance with an embodiment of the present invention;

FIG. 39 is a flow diagram of an assignment management routine for allowing an accessing importer to manage the assignment of questions and/or templates to its suppliers, in accordance with an embodiment of the present invention;

FIG. 40 is a flow diagram of the questionnaire review management routine for allowing an accessing importer to review its generated questionnaires, in accordance with an embodiment of the present invention;

FIG. 41 is a search/sort management routine for allowing an accessing importer to search and/or sort the responses to questions provided by its suppliers, in accordance with an embodiment of the present invention;

FIG. 42 is a flow diagram of a filter management routine performed by the management processing system for providing the ability for an accessing importer to filter responses provided by its suppliers, in accordance with an embodiment of the present invention;

FIG. 43 is a flow diagram of a report management routine managing supplier-provided reports, in accordance with an embodiment of the present invention;

FIG. 44 is a flow diagram of a weighting management routine performed by the management processing system for providing an accessing importer with the ability to assign weighting values, in accordance with an embodiment of the present invention;

FIG. 45 is a flow diagram of an extraction management routine performed by the management processing system for providing an accessing importer with the ability to extract information from the supply-chain processing system, in accordance with an embodiment of the present invention;

FIG. 46 is a flow diagram of a supplier management routine performed by the management processing system for managing suppliers that are part of the supply-chain processing system, in accordance with an embodiment of the present invention; and

FIG. 47 is a flow diagram of a published supplier questionnaire routine performed by the management processing system for generating and publishing custom questionnaires to a supplier, in accordance with an embodiment of the present invention.

### DETAILED DESCRIPTION OF THE PREFERRED EMBODIMENT

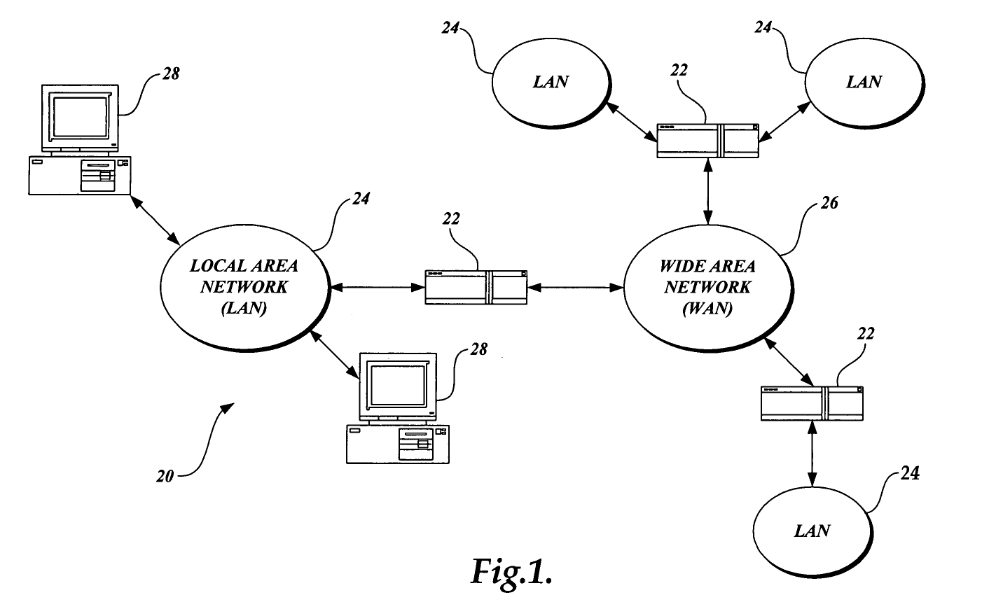

As described above, aspects of the present invention are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication links between networks may utilize 56 Kbps analog telephone lines, 1 Mbps digital T-1 lines, 45 Mbps T-3 lines, or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”) or other markup languages that are electronically stored at “WWW sites” or “Web sites” throughout the Internet. Other interactive hypertext environments may include proprietary environments, such as those provided by America Online or other online service providers, as well as the “wireless Web” provided by various wireless networking providers, especially those in the cellular phone industry. It will be appreciated that the present invention could apply in any such interactive hypertext environments; however, for purposes of discussion, the Web is used as an exemplary interactive hypertext environment with regard to the present invention.

A Web site is a server/computer connected to the Internet that has storage capabilities for storing hypertext documents and that runs administrative software for handling requests for those stored hypertext documents. Imbedded within a hypertext document are a number of hyperlinks, i.e., highlighted portions of text that link the document to another hypertext document, possibly stored at a Web site elsewhere on the Internet. Each hyperlink is assigned a Uniform Resource Locator (“URL”) that provides the exact location of the linked document on a server connected to the Internet and that describes the document. Thus, whenever a hypertext document is retrieved from any Web server, the document is considered retrieved from the World Wide Web. Known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the Web server itself.

A remote access user may retrieve hypertext documents from the World Wide Web via a Web browser program. A Web browser, such as Microsoft's Internet Explorer®, is a software application program for providing a graphical user interface to the WWW. Upon request from the remote access user via the Web browser, the Web browser locates and retrieves the desired hypertext document from the appropriate Web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the Web server, such as JAVA® applets, for execution on the client computer.

The present application is directed toward a system and method for the collection, analysis, and management of data. More specifically, embodiments of the present invention are directed toward a system and method for validation of parties within a supply-chain through the systematic solicitation, collection, monitoring, and analysis of supply-chain information in an accurate, automated, and efficient manner. Although embodiments of the present invention will be described with respect to a supply-chain processing system and security assessments, one skilled in the relevant art will appreciate that the disclosed management processing system and the disclosed embodiments are illustrative in nature and should not be construed as limiting.

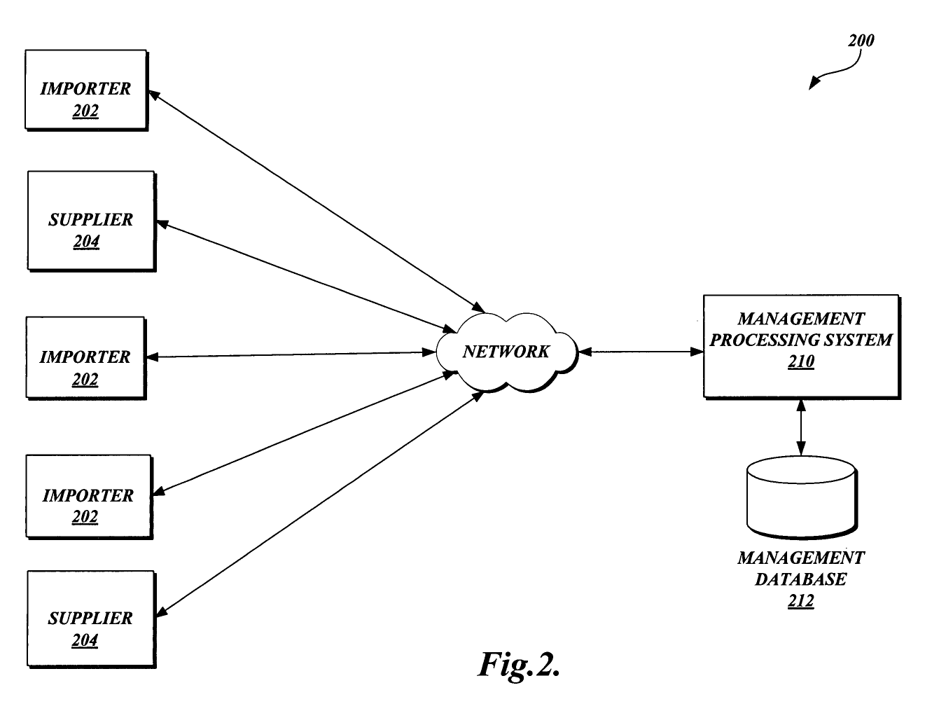

Referring now to FIG. 2, an interactive supply-chain processing system 200 for facilitating transactions between a number of parties of a supply-chain will be described. In an illustrative embodiment of the present invention, the supply-chain processing system 200 can be a private, subscriber-based system allowing a number of parties to interact via a common communication network, such as the Internet 20. Alternatively, the supply-chain processing system 200 can be a public system allowing access to any number of parties via the communication network. Still further, the supply-chain processing system 200 can also incorporate a combination of private and public communication networks.

As illustrated in FIG. 2, the supply-chain processing system 200 includes a number of importer computing devices 202 associated with one or more importers utilizing the supply-chain processing system 200. Although a limited number of importer computing devices 202 are shown in FIG. 2, the supply-chain processing system 200 can include any number of importer computing devices 202. The supply-chain processing system 200 also includes a number of supplier computing devices 204 associated with one or more suppliers utilizing the supply-chain processing system 200. Although a limited number of supplier computing devices 204 are shown in FIG. 2, the supply-chain processing system 200 can include any number of supplier computing devices 202. Further, the importer computing devices 202 and the supplier computing devices 204 can correspond to any number of computing devices, such as personal computers, hand-held computers, server computers, personal digital assistants, mobile computing devices, mobile telephones, or any combination thereof.

Each computing device 202/204 is in communication with a management processing system 210. In an illustrative embodiment of the present invention, the management processing system 210 includes a management database 212 that serves as a centralized data warehouse for managing incoming requests and specifics from each importer computing device 202, managing incoming questionnaire responses from supplier computing devices 204 and for generating and distributing the appropriate questionnaires and questionnaire management systems to computing devices, importers, and suppliers within the supply-chain processing system 200. Although the management processing system 210 is illustrated as a separate component of the supply-chain processing system 200, one skilled in the art will appreciate that an importer computing device 202 and/or a supplier computing device 204 may also provide the functionality associated with the master management system 210. Further, one skilled in the relevant art will appreciate that additional management processing systems may be incorporated into the supply-chain processing system 200 to provide for additional processing and management. For example, one group of suppliers and importers may communicate with a second management processing system (not shown), which, in turn, communicates with the management processing system 210.

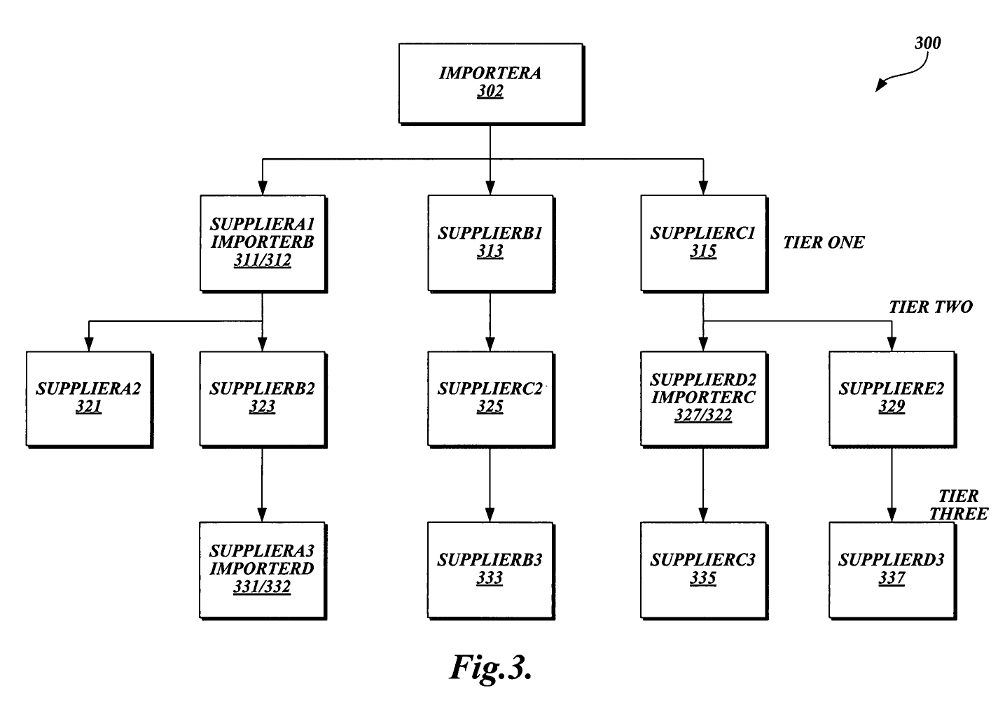

FIG. 3 is a block diagram of a three-tier supply-chain 300 for ImporterA 302. A first-tier supplier is a supplier that directly services a party in a supply-chain. For example, SupplierA1 311, SupplierB1 313, and SupplierC1 315 are all first-tier suppliers to ImporterA 302. Additionally, SupplierA2 321, and SupplierB2 323 are first-tier suppliers to SupplerA1 311. Likewise, SupplierA3 331 is a first-tier supplier to SupplierB2 323. A second-tier supplier is a supplier that is one step removed from a party in the supply-chain. For example, SupplierA2 321, SupplierB2 323, SupplierC2 325, SupplierD2 327, and SupplierE2 329 are all second-tier suppliers to ImporterA1 302. Additionally, SupplierC3 335 is a second tier-supplier to SupplierC1 315. A third-tier supplier is a supplier that is two steps removed from a party in the supply-chain. For example, SupplierA3 331, SupplierB3 333, SupplierC3 335, and SupplierD3 337 are all third-tier suppliers to ImporterA 302.

Suppliers in a supply-chain may also be importers that interact with the same and/or different suppliers of the supply-chain. For example, SupplierA1 311 is also an importer, identified as ImporterB 312. ImporterB 312 may interact with its illustrated first tier-suppliers, SupplierA2 321 and/or SupplierB2 323, or it may interact with a set of suppliers that are independent from the supply-chain 300. Thus, ImporterB 312 may have its own supply-chain (not shown). Because a party interacting within the supply-chain processing system may be both an importer and a supplier, for purposes of this application a party may be referred to herein as a “client.” A “client” may be an importer, supplier, and/or a party that is both an importer and a supplier.

While embodiments of the present invention will be described with respect to a supply-chain management system for managing clients, embodiments of the present invention are equally applicable to any type of multi-tiered system for which the collection and management of data is desired. For example, embodiments of the present invention may be utilized to manage information for a corporation having several layers of subsidiaries in which the corporation desires to maintain information with respect to those subsidiaries.

Any of the clients illustrated in supply-chain 300 may interact with embodiments of the present invention utilizing computing devices, such as the Importer computing device 202, or one of the supplier computing devices 204. Additionally, clients may also interact utilizing conventional techniques such as mail. While the supply-chain illustrated and described with respect to FIG. 3 only describes a three-tier supply-chain, one skilled in the relevant art will appreciate that any size of supply-chain, with any number of clients, may be utilized with embodiments of the present invention.

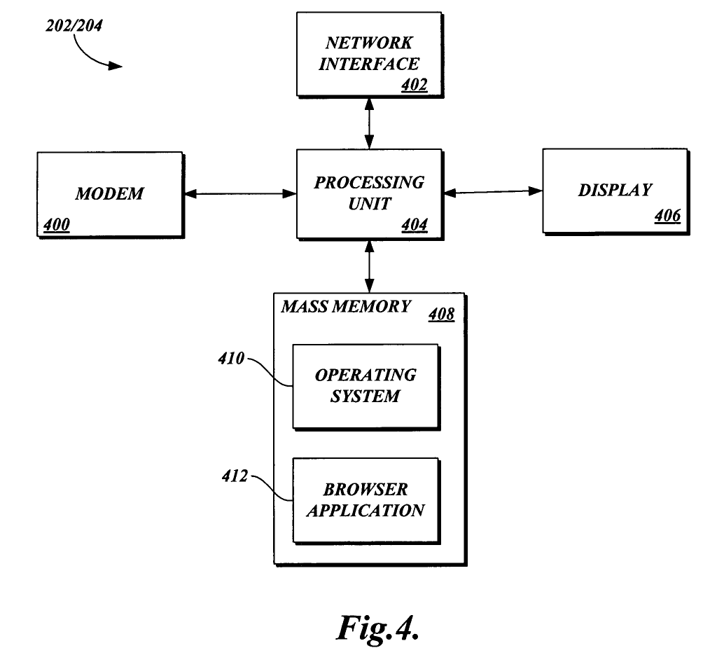

FIG. 4 depicts several of the key components of an importer computing device 202 and/or a supplier computing device 204 (FIG. 2). Those of ordinary skill in the art will appreciate that the computing devices can include more or fewer components than those shown in FIG. 4. However, it is not necessary that all of the generally conventional components be shown in order to disclose an illustrative embodiment for practicing embodiments of the present invention.

As shown in FIG. 4, each computing device 202/204 may include a modem 400 for connecting to an Internet service provider through a Point-to-Point Protocol (“PPP”) connection or a Serial Line Internet Protocol (“SLIP”) connection, as is known to those skilled in the art. The modem 400 may utilize a telephone link, cable link, wireless link, Digital Subscriber Line (“DSL”) or other types of communication links known in the art. The computing devices may also include a network interface 402 for connecting directly to a LAN or a WAN, or for connecting remotely to a LAN or WAN. Those of ordinary skill in the art will appreciate that the network interface 402 includes the necessary circuitry for such a connection, and is also constructed for use with various communication protocols, such as the TCP/IP protocol, the Internet Inter-ORB Protocol (“IIOP”), and the like. The network interface 402 may utilize the communication protocol of the particular network configuration of the LAN or WAN it is connecting to, and a particular type of coupling medium.

The computing devices also include a processing unit 404, a display 406, and a memory 408. The memory 408 generally comprises a random access memory (“RAM”), a read-only memory (“ROM”), and a permanent mass storage device, such as a hard disk drive, tape drive, optical drive, floppy disk drive, CD-ROM, DVD-ROM, or removable storage drive. The memory 408 stores an operating system 410 for controlling the operation of the importer computing device 202. The memory 408 also includes an access application for accessing the supply-chain processing system 200 via the communication network. Examples of an access application can include a WWW browser 412, such as Microsoft's INTERNET EXPLORER® browser. The access application can also include an electronic mail component for obtaining and transmitting electronic communications with other components in the supply-chain processing system 200. One skilled in the relevant art will appreciate that these components may be stored on a computer-readable medium and loaded into memory 408 of the computing device 202/204 using a drive mechanism associated with the computer-readable medium, such as a floppy, CD-ROM, DVD-ROM drive, or network interface 402. The memory 408, display 406, modem 400, and network interface 402 are all connected to the processor 404 via a bus. Other peripherals may also be connected to the processor in a similar manner.

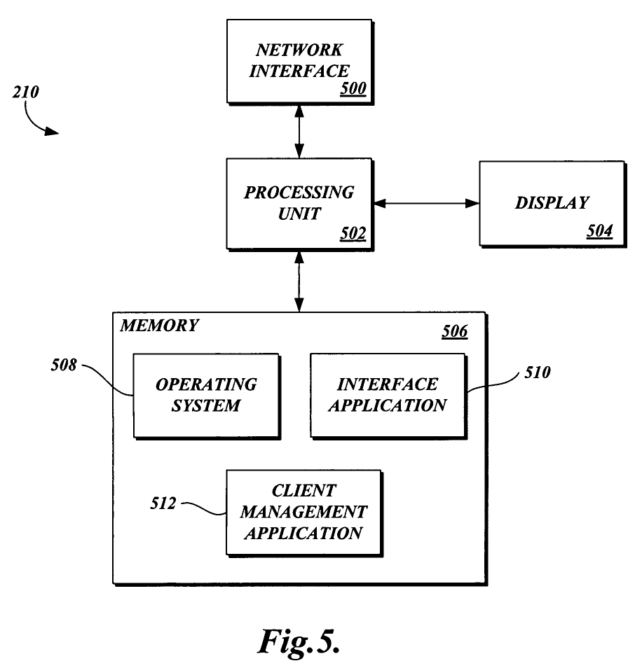

FIG. 5 is a block diagram depicting an illustrative architecture of a management processing system 210 (FIG. 2) in accordance with an embodiment of the present invention. As shown in FIG. 5, the management processing system is connected to the communication network via a network interface 500. Those of ordinary skill in the art will appreciate that the network interface 500 includes the necessary circuitry for connecting the management processing system 210 to the Internet 20, and is constructed for use with the TCP/IP protocol or other protocols, such as IIOP. The management processing system 210 also includes a processing unit 502, a display 504, and a memory 506, all connected via a communication bus or other communication device. The memory 506 generally comprises a RAM, ROM, and a permanent storage device, such as a hard disk drive, tape drive, optical drive, floppy disk drive, or combination thereof. The memory 506 stores an operating system 508 for controlling the operation of the management processing system 210. It will be appreciated that this component may comprise a general-purpose server operating system as is known to those skilled in the art, such as UNIX, LINUX™, or Microsoft WINDOWS NT®.

The memory 506 also stores program code and data for interfacing with one or more components of the supply-chain processing system 200, and for identifying and resolving discrepancies. More specifically, the memory 506 stores a component interface application 510 in accordance with an embodiment of the present invention for communicating with importer computing devices 202 and supplier computing devices 204. The memory 506 further stores a client management application 512 for generating and transmitting client requests, generating and transmitting custom questionnaires, and generating and transmitting importer-specific supplier responses. The client management application 512 may also be utilized to manage custom questions and questionnaires, including templates used to generate the custom questionnaires and individual questions contained within the custom questionnaires. The operation of the client management application 512 will be described in greater detail below. One skilled in the relevant art will appreciate that the various components may be stored on a computer-readable medium and loaded into the memory 506 using a drive mechanism associated with the computer-readable medium, such as a floppy, CD-ROM, DVD-ROM drive, or network interface 500.

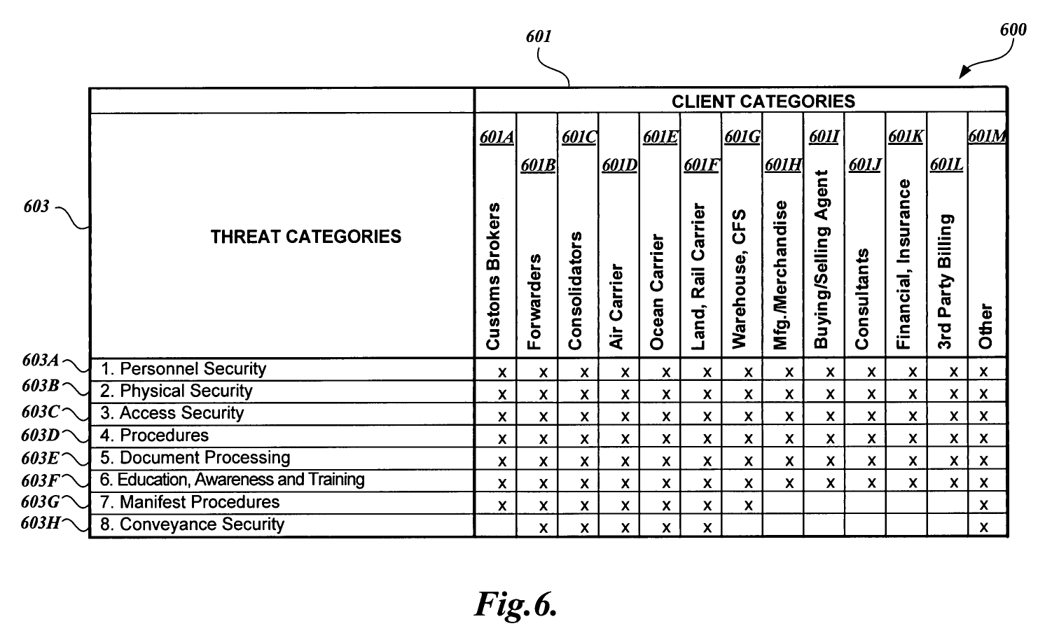

FIG. 6 is a threat matrix 600 illustrating the relationship between client categories 601 and threat categories 603. Clients, such as ImporterA 302 or SupplierB1 313, may be categorized into one or more groups of client categories 601. For example, a supplier may be categorized into one or more client categories 601, including custom brokers 601A, forwarders 601B, consolidators 601C, air carrier 601D, ocean carrier 601E, land/rail carrier 601F, warehouse/CFS 601G, manufacturing/merchandise suppliers 601H, buying/selling agents 601I, consultants 601J, financial/insurance 601K, third-party billing 601L, and/or other 601M. Additionally, each of the client categories 601 may have one or more threat categories 603 that are related to that particular client category 601. In particular, threat categories 603 may include personnel security 603A, physical security 603B, access security 603C, procedures 603D, document processing 603E, education, awareness and training 603F, manifest procedures 603G, and conveyance security 603H.

A client, such as SupplierA1 311, may be associated with multiple client categories 601, such as air carrier 601D, land/rail carrier 601F, and manufacturing/merchandise supplier 601H. As illustrated in the threat matrix 600, the threat categories 603 associated with the air carrier 601D category include each of the potential threat categories.

The air carrier 601D category includes the associated threat categories of personnel security 603A, physical security 603B, access security 603C, procedures 603D, document processing 603E, education, awareness and training 603F, manifest procedures 603G, and conveyance security 603H. Likewise, the land/rail carrier 601F category also has associated with it each of the eight threat categories 603. The manufacturing/merchandise supplier 601H category only has associated with it six of the eight threat categories. In particular, the manufacturing/merchandise supplier 601H is associated with the threat categories of personnel security 603A, physical security 603B, access security 603C, procedures 603D, document processing 603E, and education, awareness and training 603F.

While the threat matrix 600 only describes 13 potential client categories 601, one skilled in the art will appreciate that more or fewer client categories may be included in the threat matrix 600. Additionally, while threat matrix 600 only describes eight potential threat categories, one skilled in the art will appreciate that more or fewer threat categories may be associated with clients in client categories, as illustrated in the threat matrix 600.

As will be described herein, each of the threat categories may have a particular set of “baseline questions” that may be associated with suppliers that identify and/or are related to that threat category. Baseline questions, as referred to herein, are a set of one or more questions that are applicable to a particular threat category.

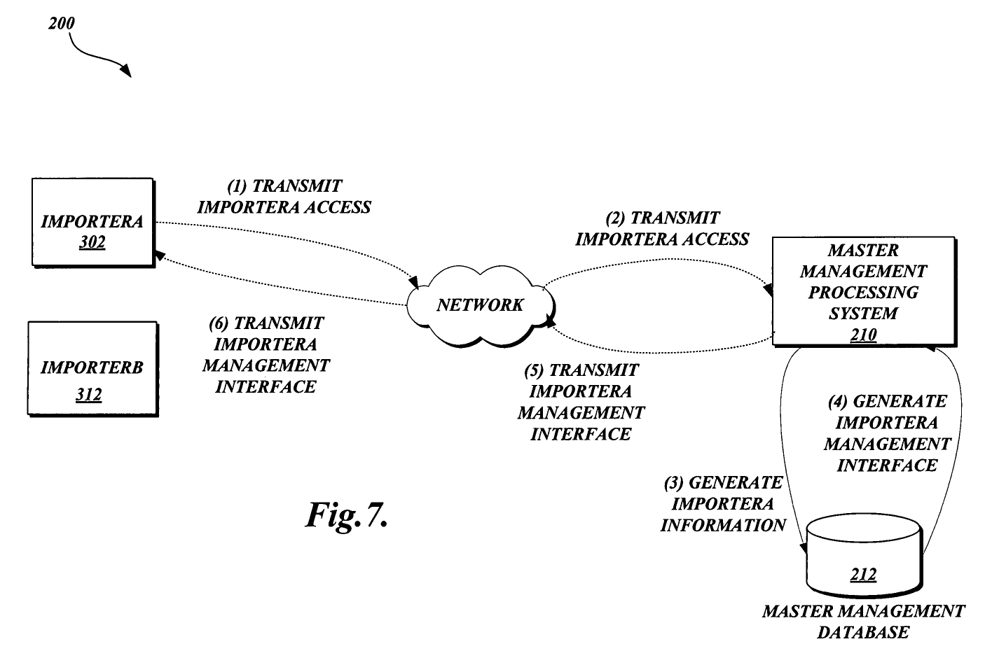

Referring now to FIGS. 7, 8, 9, 10, 11, and 12, a general example of the supply-chain processing system 200 and the interaction between two client importers utilizing the supply-chain processing system 200 and a management processing system according to an embodiment of the present invention will be described. In this example, we will assume that both importers are accessing the system for the first time. FIG. 7 is a block diagram of a portion of the supply-chain processing system 200 (FIG. 2) illustrating the access of a client, ImporterA 302, and the generation of a questionnaire management interface for the particular ImporterA 302, in accordance with an embodiment of the present invention.

As illustrated in FIG. 7, ImporterA 302 initiates access with the management processing system 210. In an illustrative embodiment of the present invention, ImporterA 302 accesses the supply-chain processing system 200 utilizing an importer computing device 202 (FIG. 2). For example, ImporterA 302, utilizing an importer computing device 202, may access the supply-chain processing system 200 through the Internet using the World Wide Web and a Web browser, such as Microsoft's INTERNET EXPLORER®. ImporterA 302 may access the system by providing a user name and other log-in credentials that identify it to the management processing system 210. As will be appreciated by one skilled in the relevant art, any type of accessing technique may be used with embodiments of the present invention to identify an importer to the supply-chain processing system 200. As such, the variety of techniques will not be described herein.

The management processing system 210 receives the incoming ImporterA 302 access request, reviews the information provided by ImporterA, and determines the status of ImporterA 302 with respect to the overall supply-chain processing system 200. In response, a particular interface for interacting with the management processing system 210 is generated by the management processing system 210 and management database 212. For example, if this is the first time ImporterA 302 has accessed the supply-chain processing system 200, the management processing system 210 will generate a particular management interface that requests that ImporterA 302 provide additional information to the supply-chain processing system 200 and, in particular, to the management processing system 210. The management interface generated for a client accessing the system for the first time would include requests for client specific information, such as the importer's name, address, certificates with appropriate authorities, threat categories for which it qualifies, contact information, etc. Additionally, an accessing client may also be required to answer baseline questions about itself for each threat category it identified.

Upon generation of a particular ImporterA management interface, the management processing system 210 transmits the interface to ImporterA 302. As illustrated in FIG. 7, the management processing system 210 may transmit the interface to ImporterA 302 via the communication network. In an illustrative embodiment of the present invention, the interface may be in the form of a Web access interface.

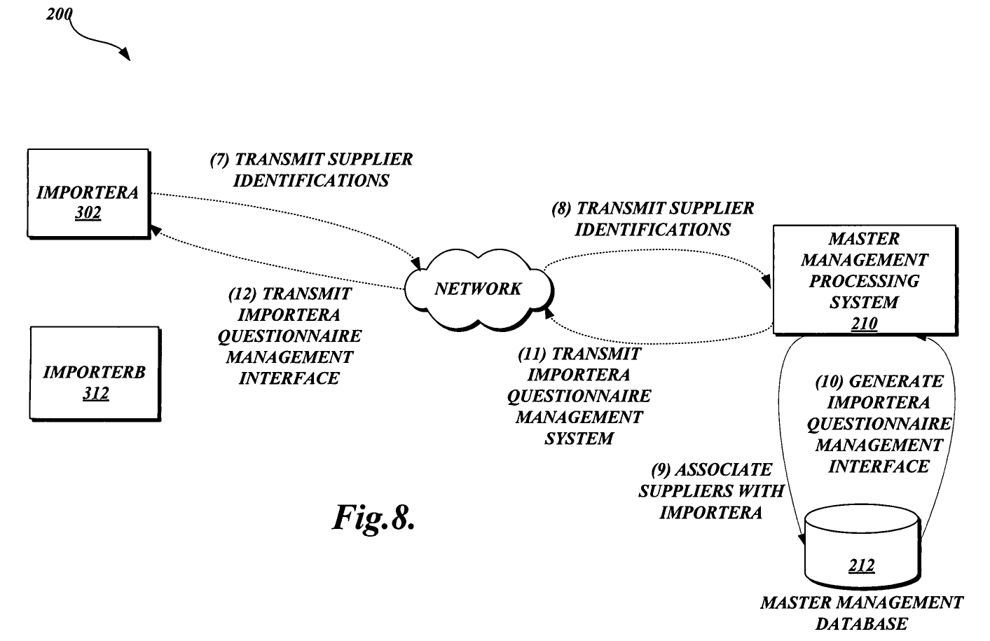

With reference now to FIG. 8, after the ImporterA management interface has been received by ImporterA 302, ImporterA 302 provides initial information regarding itself and its threat categories. Additionally, as illustrated in FIG. 8, ImporterA 302 may transmit an identification of each supplier for which it currently, or desires to, transact business. Upon receiving supplier identifications, management processing system 210 associates each of the identified suppliers with ImporterA 302 and generates an ImporterA questionnaire management interface. The generated ImporterA questionnaire management interface is transmitted to ImporterA 302 via the communication network. As will be described in detail below, the ImporterA questionnaire management interface is particular to ImporterA 302, depending upon the types of threat categories identified by ImporterA and based upon the identification of particular suppliers. Additionally, the questionnaire management interface is custom depending upon whether the accessing client is accessing the system as an importer or a supplier.

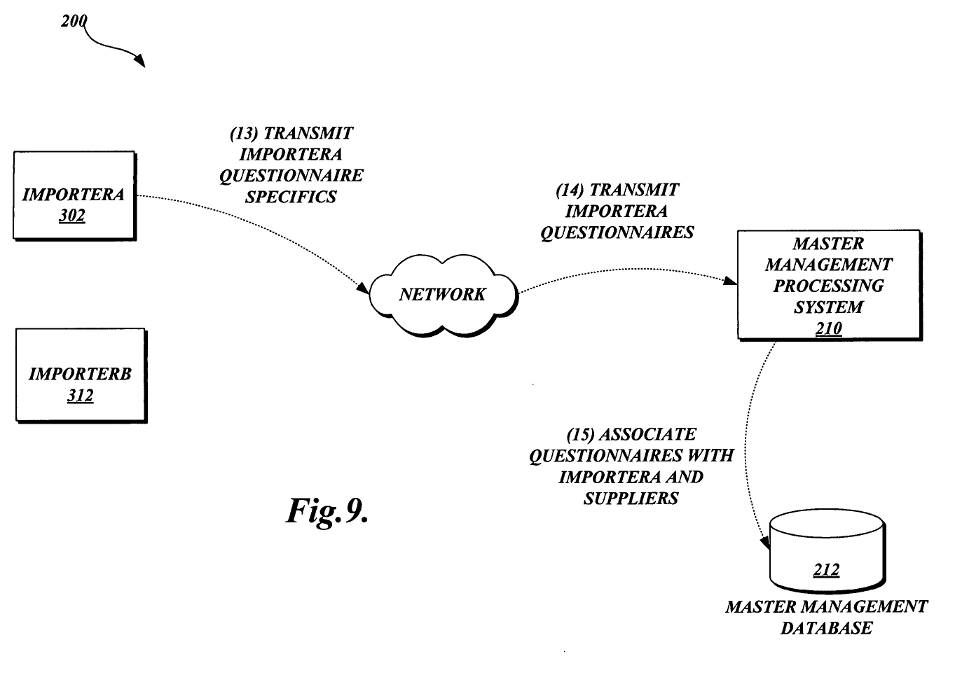

With reference now to FIG. 9, after receipt of the ImporterA questionnaire management interface, ImporterA 302 generates specific questionnaires and/or specific questions for each of its identified suppliers. ImporterA 302, using the ImporterA questionnaire management interface, has the ability to select preexisting questions that are associated with potential threat categories of the identified suppliers, modify existing questions, create new questions, and manage different portions of questionnaires for each of the particular suppliers identified. After ImporterA 302 has completed the questionnaires for its suppliers, the ImporterA questionnaires are transmitted to the management processing system 210. The management processing system 210, upon receipt of ImporterA's questionnaires, associates those questionnaires with ImporterA and with the appropriate suppliers. In an illustrative embodiment of the present invention, some portions of the questions may be fixed and/or refined for each supplier. At this point, ImporterA 302 may exit the system or remain active and perform other tasks.

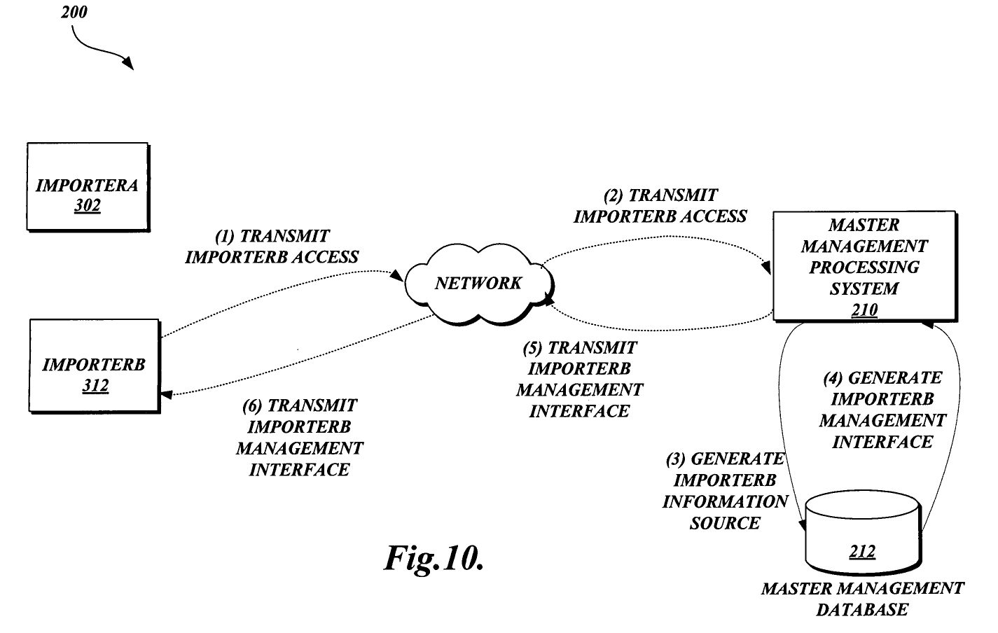

With reference now to FIG. 10, a second client, ImporterB 312 accesses supply-chain processing system 200. As described above with respect to ImporterA 302, ImporterB 312 transmits an ImporterB access request through communication network to the management processing system 210. The management processing system 210 determines the status of ImporterB 312 with respect to the supply-chain processing system 200. Again, assuming that this is the first time ImporterB 312 has accessed the supply-chain processing system 200, management processing system 210 generates an ImporterB management interface that requests information about the importer. Once the ImporterB management interface has been generated, it is transmitted via a communication network to ImporterB 312.

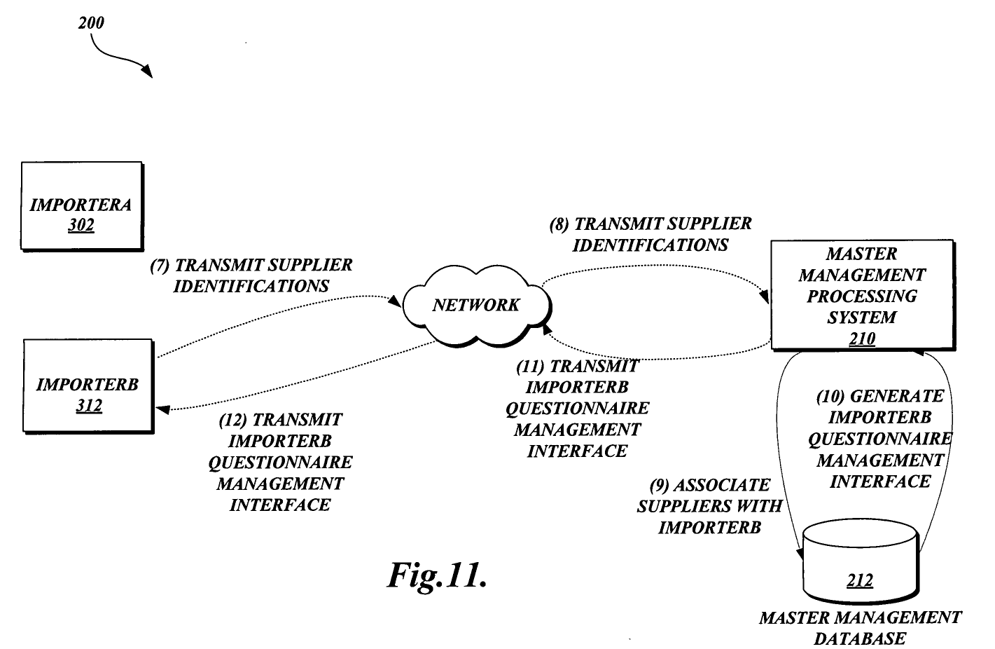

ImporterB 312, in response to receiving ImporterB management interface, as illustrated in FIG. 11, provides particular information for itself, identifies its threat categories, answers the appropriate baseline questions, and identifies suppliers for which it desires to conduct business and/or is currently conducting business. That information is transmitted to the management processing system 210, which, in response, associates the identified suppliers with ImporterB. Additionally, management processing system 210 generates an ImporterB questionnaire management interface. The ImporterB questionnaire management interface is particular to ImporterB 312 and may be distinct from the ImporterA questionnaire management interface that was generated and provided to ImporterA 302. The interfaces are generated for particular importers based on the unique needs of the importer. For example, ImporterA may only be concerned with clients that are suppliers having associated client categories, such as manufacturing/merchandise supplier 601H and consultants 601J. However, ImporterB 202B may be interested in clients associated with client categories 601, such as the forwarders 601B category and the air carrier 601D category. Those client categories are associated with different threat categories.

Referring back to FIG. 6, clients falling into client categories, such as the manufacturing/merchandise 601H category and the consultants 601J category, are only associated with the threat categories of personnel security 603A, physical security 603B, access security 603C, procedures security 603D, document processing 603E, and education, awareness and training 603F. In contrast, the forwarders 601B category and the air carrier 601D category are associated with all eight of the threat categories—personnel security 603A, physical security 603B, access security 603C, procedures 603D, document processing 603E, education, awareness and training 603F, manifest procedures 603G, and conveyance security 603H.

Additionally, questionnaire management interfaces generated for clients are also custom to each client because they provide each importer with the ability to create its own specific questions, modify baseline questions, add questions to questionnaires, and otherwise manage supplier questionnaires. Still further, questionnaires are custom to each importer, depending upon the suppliers identified by those importers. However, some portion of other importer information may be used as a template for facilitating the customization of importer questionnaires.

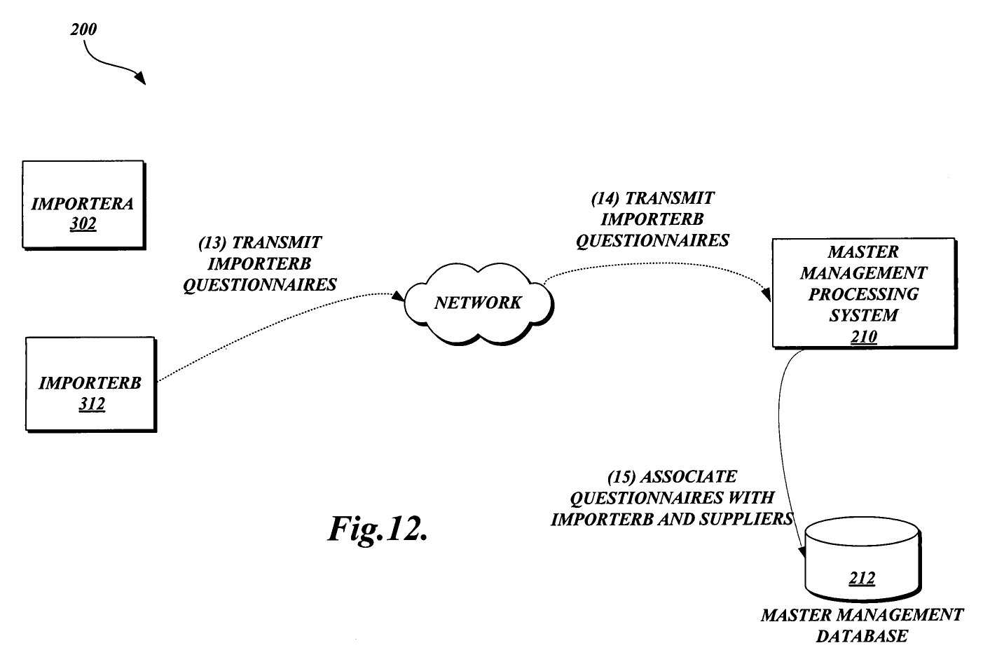

As illustrated in FIG. 12, in response to receiving the ImporterB questionnaire management interface, ImporterB 312 generates the particular questionnaires for its identified suppliers and those questionnaires are transmitted to the management processing system 210. As described above with respect to ImporterA 302, the questionnaire management interface provided to ImporterB, which is specific to ImporterB 312, allows ImporterB 312 to, among other things, select particular questions for its identified suppliers, create new questions for its identified suppliers, identify new suppliers, modify existing questions for identified suppliers, and manage other information about itself and its suppliers. Upon receipt of the ImporterB questionnaires by management processing system 210, management processing system 210 associates the questionnaires with ImporterB and the appropriate suppliers identified by ImporterB 312.

The interaction between importers, such as ImporterA 302 and ImporterB 312, with the management processing system 210 can continue indefinitely. The description of two importers interacting with the management processing system 210 was selected for discussion purposes only and any number or combination of importers identifying any number and combination of suppliers may be supported by embodiments of the present invention. Additionally, the interaction of clients, such as ImporterA 302 and ImporterB 312, with management processing system 210 is independent of one another. Multiple clients may interact with management processing system 210 at the same time.

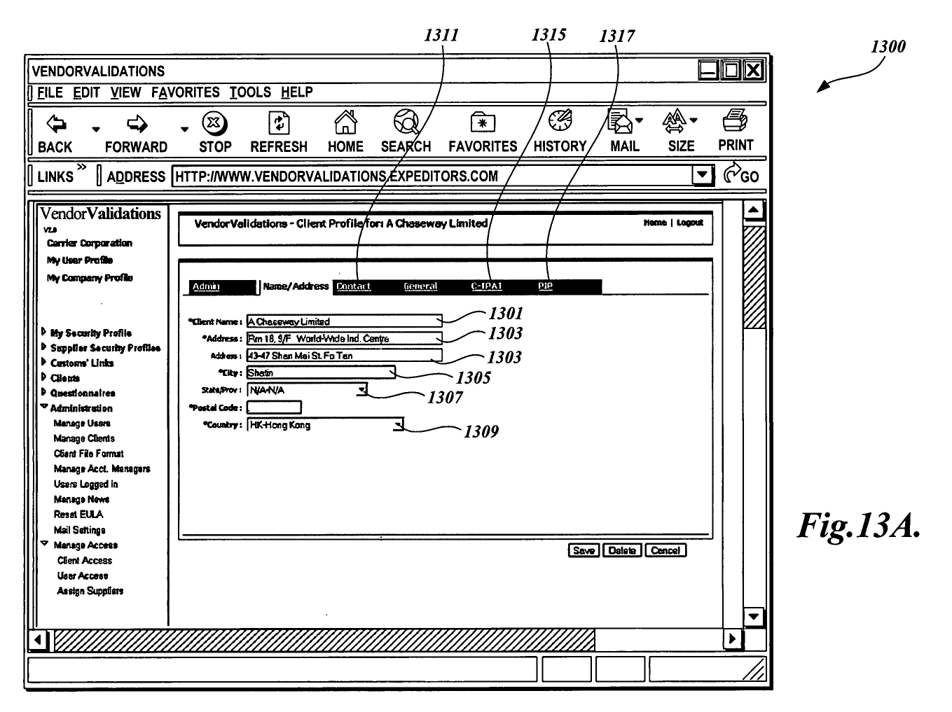

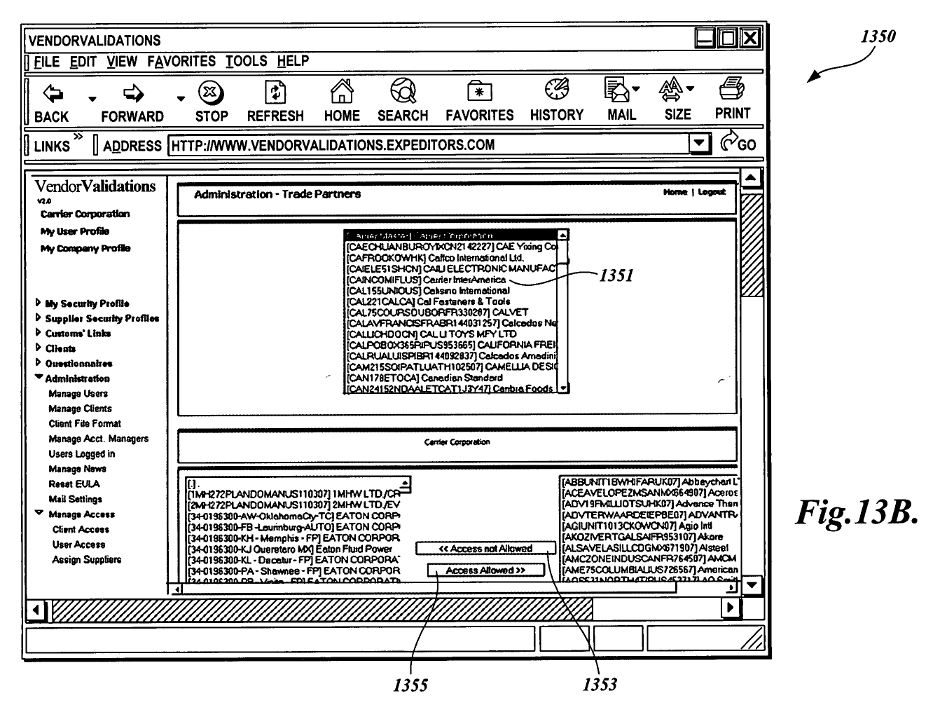

With reference now to FIGS. 13A-21, a set of illustrative screen displays corresponding to aspects of the present invention will be described. Although the screen displays correspond to particular information associated with security certification for the C-TPAT, one skilled in the relevant art will appreciate additional and/or alternative screen displays or data fields may be utilized in conjunction with embodiments of the present invention.

FIG. 13A is a block diagram illustrative of a client management interface screen display 1300 generated by management processing system 210 for obtaining the initial information from an accessing client in accordance with an embodiment of the present invention. As described above, in response to a client, such as ImporterA 302 or SupplierB 313, accessing the supply-chain processing system 200 for the first time, management processing system 210 generates a client management interface 1300 and requests that the accessing client provide additional information. For example, an accessing client may be requested to provide a client name 1301, client address 1303, the city in which the client is located 1305, a state 1307 in which the client is located, and a country 1309 in which the client is located. Additionally, an accessing client may be requested to provide contact 1311 specific information and an indication of whether it is certified pursuant to the Customs Trade Partnership Against Terrorism (“C-TPAT”) joint initiative 1315, as well as whether the accessing client is certified pursuant to Partners-In-Protection (“PIP”) 1317. The information provided by an accessing client through client management interface 1300 may be utilized to identify the client during future access attempts to the system, to identify the client to other clients of the supply-chain processing system 200, and to generate additional information and interfaces for the accessing client.

FIG. 13B illustrates a block diagram of a supplier identification screen display 1350 for allowing a client, such as ImporterA 302, to identify its suppliers. As described above, in response to an initial access by a client, the management processing system 210 requests additional information, as described with respect to FIG. 13A, and requests that if the accessing client interfaces with any suppliers, it identify the suppliers for which it is currently transacting business and/or for which it desires to transact business. A client, utilizing the supplier identification interface 1350, may identify one or more of its suppliers, such as carrier InterAmerica 1351, for which it is currently conducting business. Additionally, a client may select a supplier and designate whether that supplier is denied access 1353 to information about the accessing client, or whether the selected supplier is allowed access 1355 to information about the accessing client.

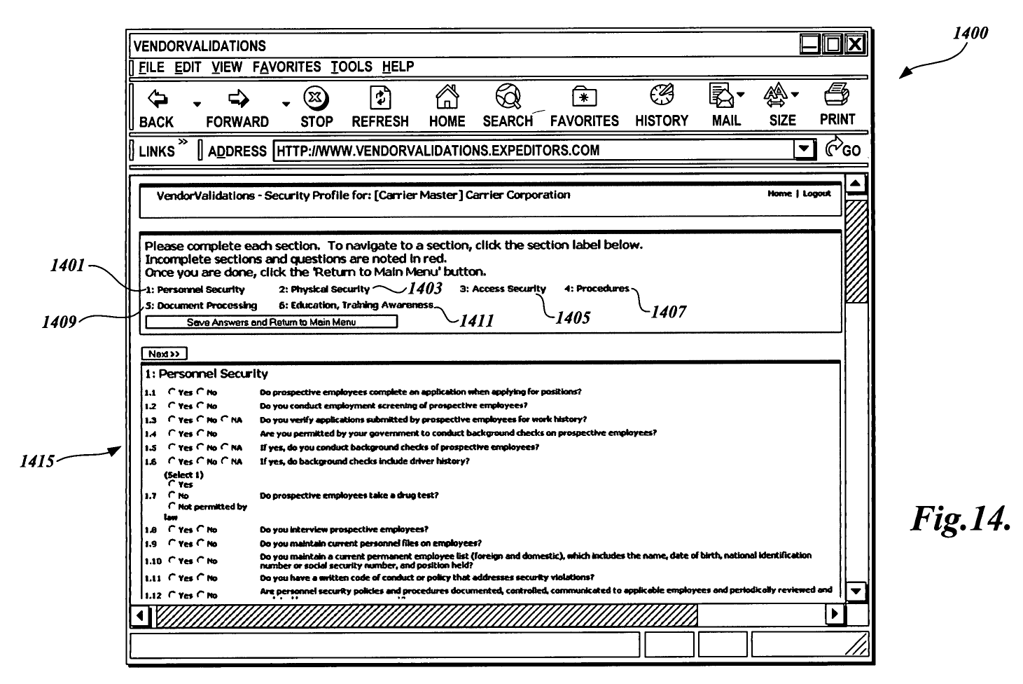

FIG. 14 is a block diagram of a set of baseline questions generated by the management processing system 210 in response to initial access to the supply-chain processing system 200 by a client. Once an initial accessing client has identified threat categories for which it is associated, the management processing system 210 may generate and provide a set of baseline questions for each of those threat categories. For example, in response to an accessing client identifying that it was associated with the threat categories of: personnel security 1401, physical security 1403, access security 1405, procedures 1407, document processing 1409, education, awareness, and training 1411, management processing 210, management processing 210 will generate and transmit an initial set of baseline questions 1400 for each of those threat categories. Selection by an accessing client of one of the threat categories 1401, 1403, 1405, 1407, 1409, 1411 will provide to the accessing client the generated and transmitted set of baseline questions 1415 for the selected threat category. A client's responses to the baseline questions provided in baseline question screen display 1400 may be utilized to review the security standards of that client, regardless of whether that client is an importer and/or a supplier. Additionally, responses to the baseline questions may be provided to other clients of the supply-chain processing system 200.

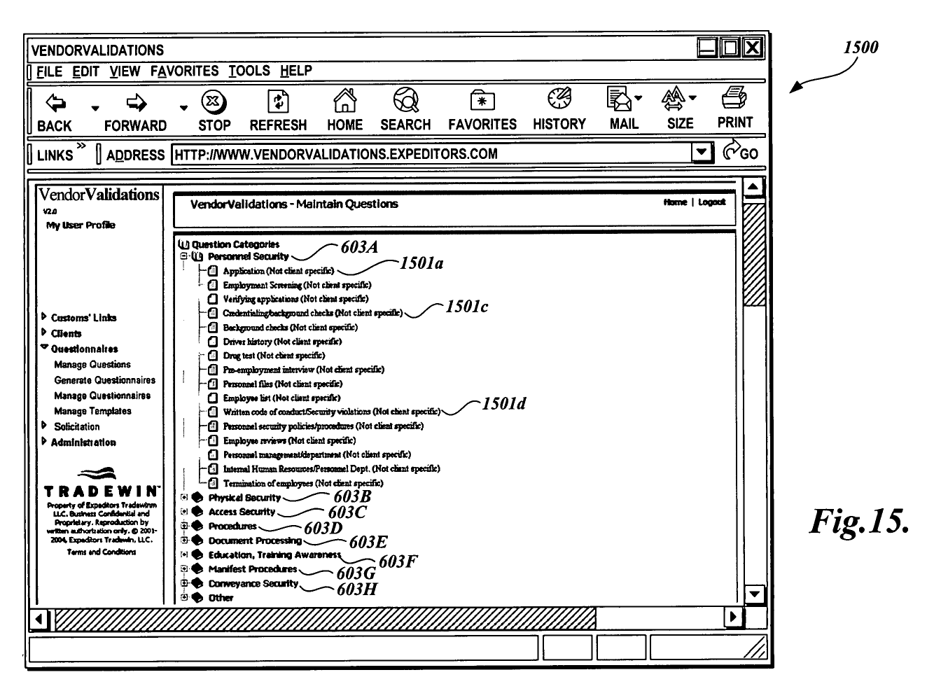

FIG. 15 is a block diagram illustrative of a question management interface screen display 1500 of a questionnaire management interface, such as the ImporterA questionnaire management interface, according to an embodiment of the present invention. The question management interface 1500 may include a list of question titles, such as application 1501A, credentialing/background checks 1501C, and written code of conduct/security violations 1501D. The question titles are organized by threat category, such as personnel security 603A, physical security 603B, access security 603C, procedures 603D, document processing 603E, education, awareness, and training 603F, manifest procedures 603G, and conveyance security 603H.

Question management interface 1500 allows a client, such as ImporterA 302, to view and manage all types of questions, whether client specific or applicable to all clients. Each of the questions is identified by a title, such as application 1501A, for easy viewing and categorization, and organized by the threat category for which they are associated, such as personnel security 603A. Each of the threat categories, such as personnel security 603A, includes the baseline questions that are applicable to that particular threat category. When questions are generated for a particular client that is associated with a particular threat category, baseline questions for that category will be included in the questions. However, if a particular client has already answered the some or all of the questions, the answered questions will not be included in a generated set of questions. Additionally, if a client has been certified, for example, by C-TPAT or PIP, it may not be required to complete all of the baseline questions based upon its certification.

In the question management interface 1500, the same question may appear in multiple threat categories. For example, the question titled application 1501A may appear in the threat categories of personnel security 603A, access security 603C, procedures 603D, and conveyance security 603H. In such an instance, if a client is associated with multiple categories containing the same question, that question may only be generated for answering under one of the threat categories.

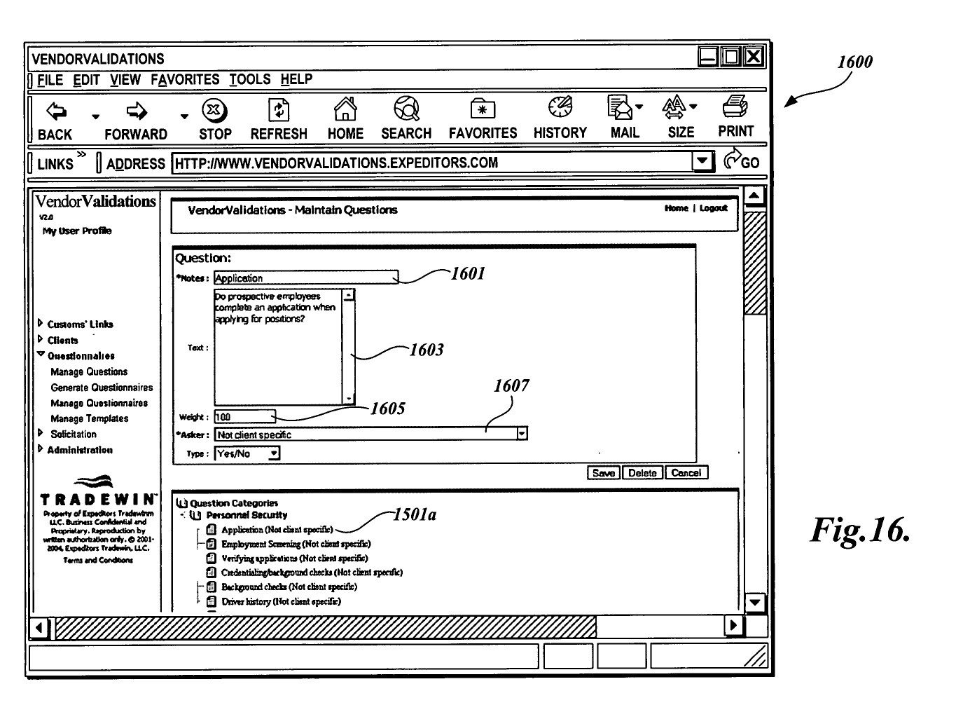

FIG. 16 is a block diagram illustrative of a question revision screen display 1600 of a questionnaire management interface, according to an embodiment of the present invention. The question revision screen display 1600 may be accessed by an importer by selecting a particular question title, such as application 1501A illustrated in question management screen display 1500. The question revision screen display 1600 provides an importer with the particular question identified by the question title illustrated in question management screen display 1500. For example, the question associated with application 1501A is “Do prospective employees complete an application when applying for positions?” as illustrated in question box 1603. In addition to being able to view the particulars of a question, an importer may also modify the question by editing the text of the question contained in question box 1603.

The question revision screen display 1600 also provides an importer with the ability to assign a particular weight to the selected question by including a weighting factor in weighting box 1605. The weighting factor may be in the form of a value, multiplier, fraction, etc. The weighting factor allows an importer to specify the importance of a particular question with respect to other questions that are issued and answered by a client. Weighting of questions may be used by an importer to score its suppliers or to identify suppliers that have higher/lower scores to particular questions.

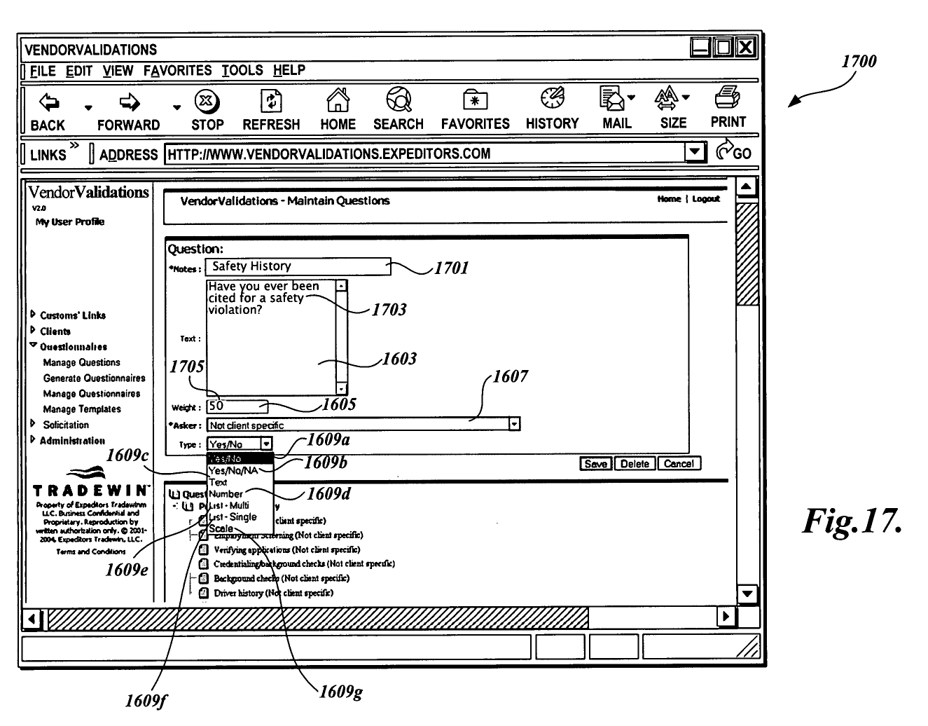

Still further, the question revision screen display 1600 allows an importer to specify whether the particular question is client specific and/or identify one or more particular clients by selection of the appropriate choice in box 1607. The importer may also indicate the type of question that is being asked by selection of question type 1609. In particular, with reference to FIG. 17, an importer may indicate whether the question is to be answered with a YES/No 1609A, YES/No/NA 1609B, text 1609C, number 1609D, list-multi 1609E, list-single 1609F, or scale 1609G.

Additionally, the question revision screen display 1600 provides an importer with the ability to create its own questions. In particular, an importer utilizing the question revision screen display 1600 may identify a title for a particular question by inserting a question title in note box 1601, typing in the particular question in question box 1603, assigning a weighting factor utilizing weight box 1605, identifying whether the question is supplier specific by selection of box 1607, and indicating a type of answer by selection of type box 1609. For example, referring to FIG. 17, an importer may create a question titled Safety History 1701 that includes the question “Have you ever been cited for a safety violation?” 1703. The importer may also assign a weighting factor in weight box 1605, such as a weighting factor of 50, as identified by label 1705. Additionally, the importer may identify whether or not the question is client specific through the use of box 1607. Selection of not-client-specific for the type indicates that the question will be included in all questionnaires issued to clients identified by the importer that has created this question. Finally, an importer may identify, through use of type box 1609, the answer type required for the newly created question. For example, an importer may select that the question be answered with a YES/No 1609A, a YES/NO/NA 1609B, a text answer 1609C, a number 1609D, a list-multi 1609E, a list-single 1609F, or a scale 1609G.

Templates may also be created within the supply-chain processing system 200 for certain categories and types of questions. One skilled in the relevant art will appreciate that templates are a collection of one or more questions. Templates may consist of baseline questions that an importer can add, edit, or change for a particular client, threat category, or client category. For example, a question template may exist for the customs brokers 601A category. Another template may exist for the forwarder 601B category, another for the consolidators 601C category, another for the air carrier 601D category, another for the ocean carrier 601E category, etc. Templates may also exist for threat categories, such as personnel security 603A, procedures 603D, conveyance security 603H, etc. Templates may be specific to the importer or standard across all importers. For example, templates may be custom created by a client and include any combination of questions.

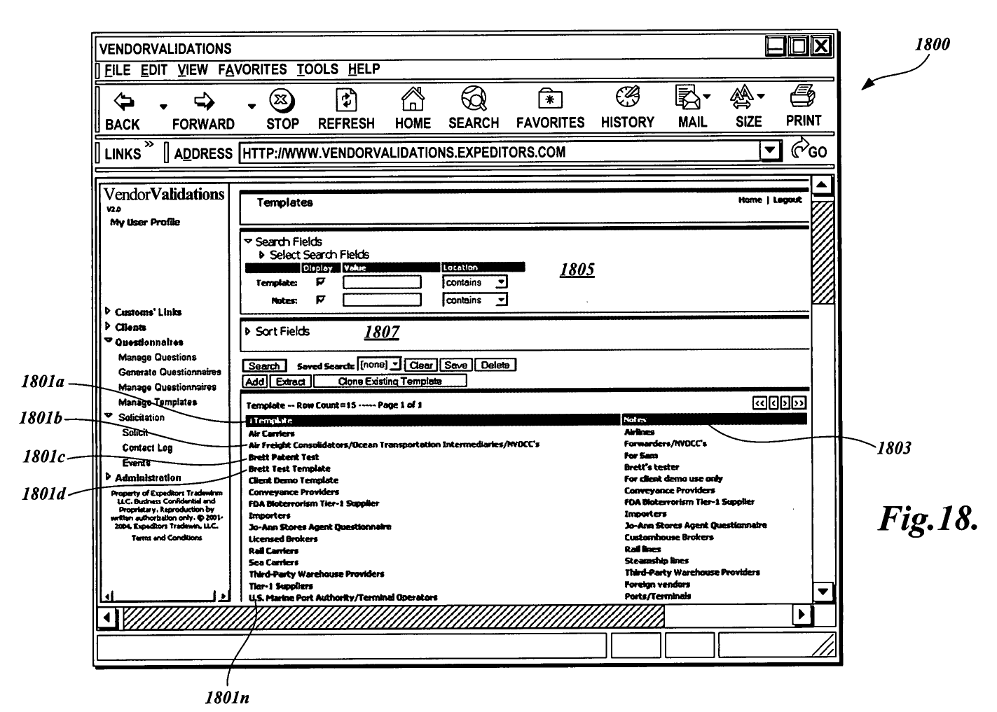

FIG. 18 illustrates a block diagram of a template management screen display 1800 of a questionnaire management interface, according to an embodiment of the present invention. The template management screen display 1800 includes a list of templates 1801A, 1801B, 1801C, through 1801N. It will be appreciated that any number of templates may be illustrated within template management screen display 1800. Each of the templates may also include a note 1803 that is added to the template to further identify the template.

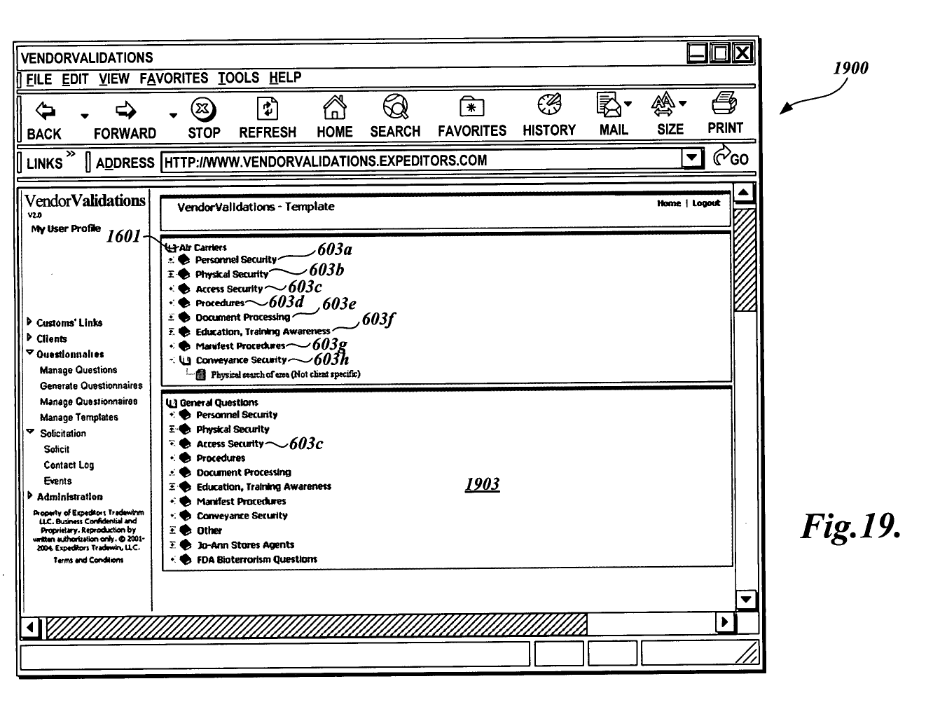

The template management screen display 1800 provides a client with the ability to search for particular templates by template name and/or by the note associated with a particular template utilizing a search parameter 1805. Still further, the template management screen display 1800 provides the ability to sort templates by sort fields, utilizing sort field parameter 1807. Upon selection of a template, such as air carrier template 1801B, a template review screen display 1900 is provided to a client, as illustrated in FIG. 19.

The template review screen display 1900 displays the selected template, such as air carrier 1601B, and the question titles of the questions associated with the selected template, organized by threat category 603A, 603B, 603C, 603D, 603E, 603F, 603G, 603H. Also included in the template review screen display 1900 is a reproduction of question management screen display 1500, illustrated in sub-display 1903. As described above with respect to FIG. 15, the baseline questions are organized by threat category for selection and review by an importer. Displaying the baseline questions in sub-display 1903 allows the importer to select baseline questions and assign them to a particular question category within the selected template 1601B. For example, an importer may select a question out of the access security 603C threat category displayed in sub-display 1903 and include it in the access security category associated with air carrier template 1601B.

Selection of any of the identified categories expands that category to identify each title of the questions associated with that threat category for the selected template 1601B. For example, selection of conveyance security category 603H associated with air carrier 1601B expands to show a question titled “physical search of area” 1905. Additionally, an indication of whether a particular question is supplier specific is presented in template review screen display 1900. Utilizing template review screen display 1900 allows an importer to review questions associated with a particular template, add questions to the particular template, and/or remove questions from a particular template.

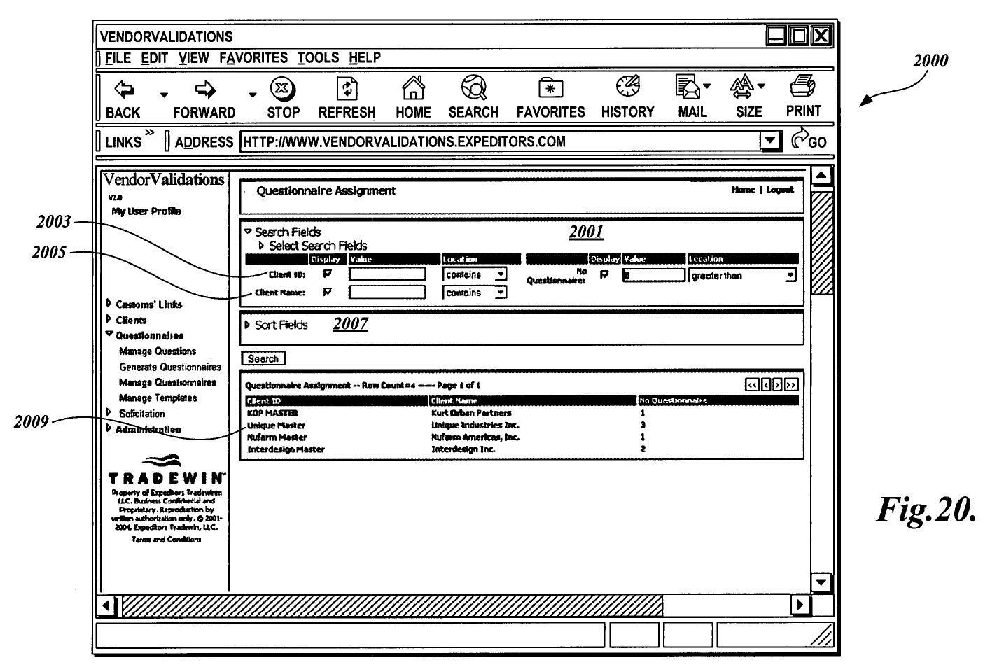

FIG. 20 illustrates a block diagram of a questionnaire assignment screen display 2000 of a questionnaire management interface, according to an embodiment of the present invention. Questionnaire assignment screen display 2000 provides an importer with the ability to assign particular questions to its identified clients. An importer may search for particular clients utilizing the search field 2001. The search field 2001 allows an importer to indicate a client ID 2003 and/or a client name 2005, for which a particular search is to be conducted. Additionally and/or alternatively, an importer utilizing questionnaire assignment screen display 2000 may sort particular fields utilizing sort field parameter 2007. The results of a search or sort performed utilizing search field 2001 or sort field 2007 results in an identification display 2009, illustrating the information matching the search parameters.

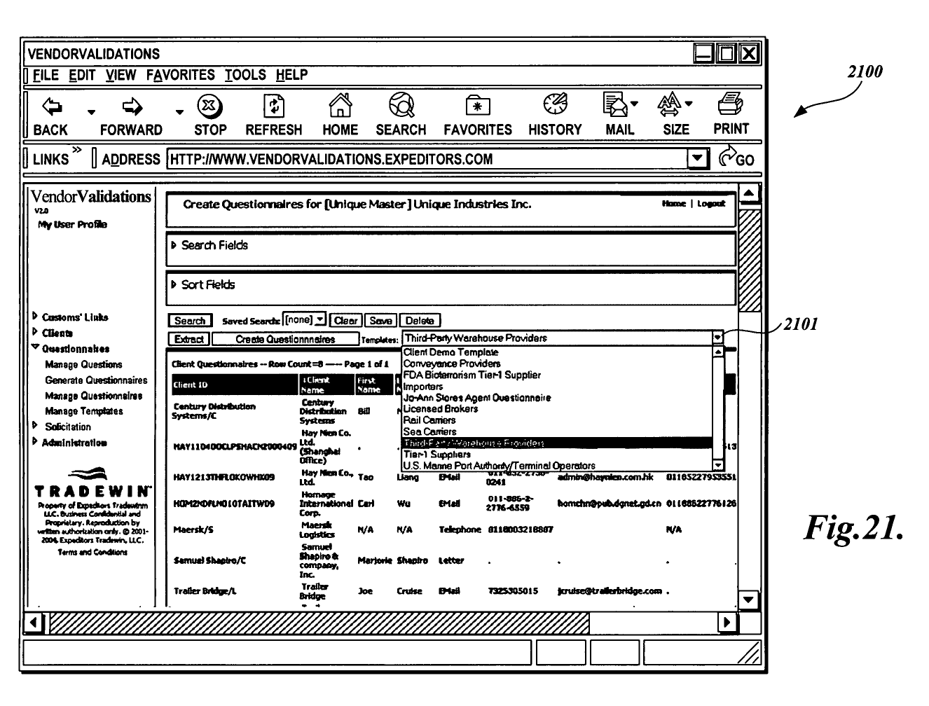

Selection of a client ID from the matching client list 2009 provides an importer with a second question assignment screen display 2100, as illustrated in FIG. 21, according to an embodiment of the present invention. In the second question assignment screen display 2100, an importer may select particular templates for which it desires to be associated with the selected client utilizing template selection window 2101. An importer may select one or more templates to be associated with the selected client, which will be used when generating a questionnaire for that particular client. As described above, templates and questionnaire generation are customized to a particular importer for a particular client. Upon creation of a questionnaire utilizing the second question assignment screen display 2100, the management processing system 210 assigns the selected templates to the importer and to the particular client for which the templates were assigned. That information will be later utilized when creating a custom questionnaire for that particular client.

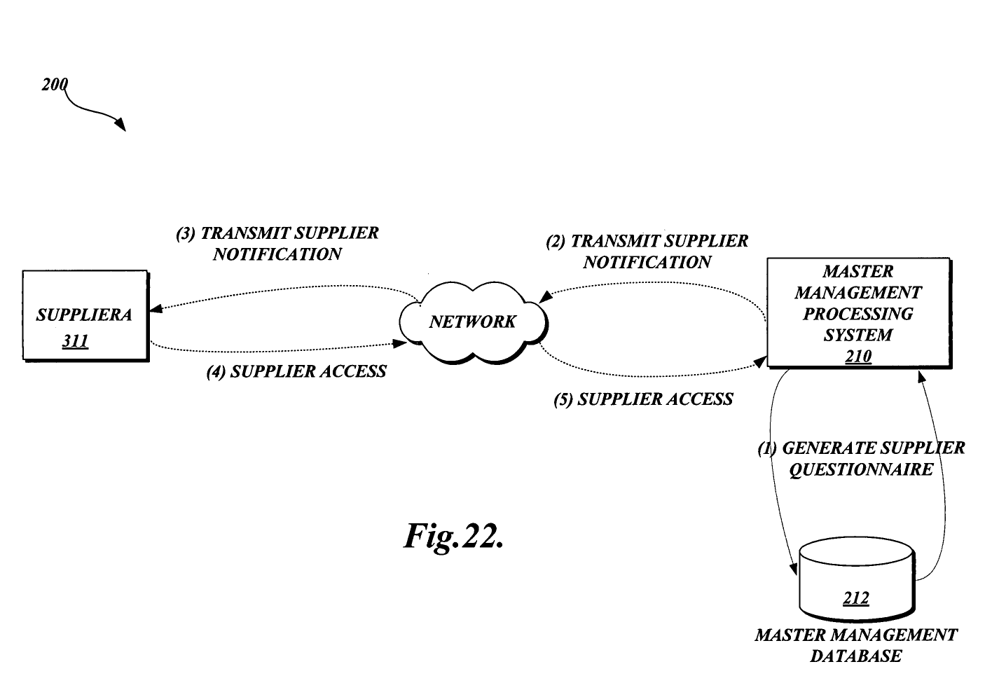

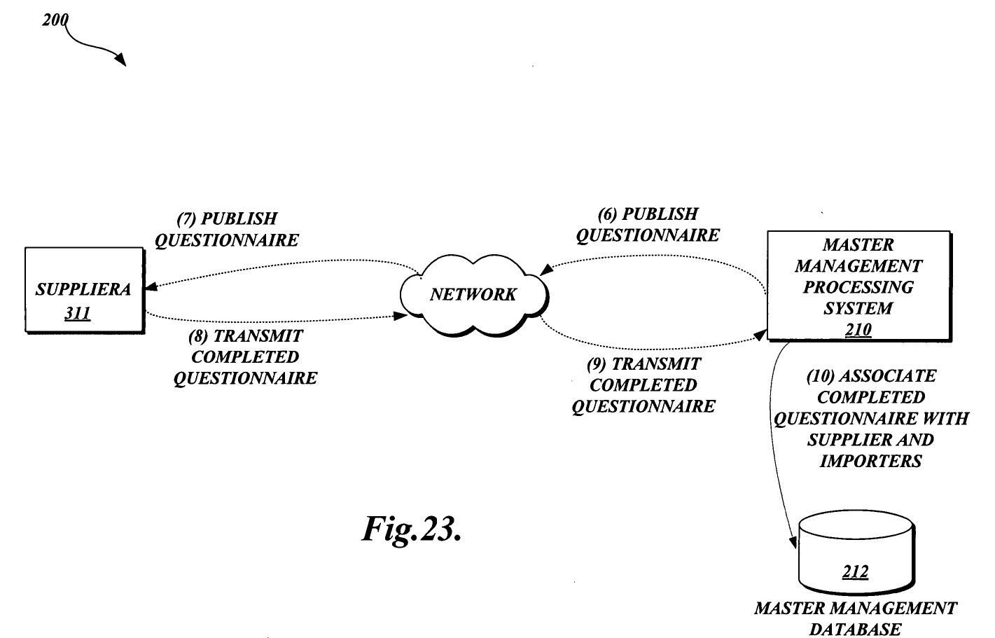

FIGS. 22 and 23 illustrate a block diagram for a second portion of the supply-chain processing system 200, including a third client SupplierA 311, in communication with management processing system 210 via a communication network, according to an embodiment of the present invention. The example described with respect to FIGS. 22-23 is a continuation of the example described with respect to FIGS. 7-12. In particular, as described above with respect to FIG. 7-12, ImporterA 302 and ImporterB 312 provided specific questionnaires for respective clients to management processing system 210. For explanation purposes it will be assumed that ImporterA 302 and ImporterB 312 both created questionnaires for SupplierA 311 and that each questionnaire included questions unique to that questionnaire.

Once the management processing system 210 has received questionnaires for a particular client, it generates one custom questionnaire which is transmitted to the particular client, such as SupplierA 311. The custom questionnaire is generated by the management processing system 210 by compiling all the questions from the individual questionnaires generated by the importers for a particular client and removing duplicate questions. For example, the questionnaire generated by ImporterA 302 for SupplierA 311 may include five questions that were created by ImporterA 302 and a group of baseline questions for the threat category personnel security 603A, and the questionnaire created by ImporterB 312 for the same SupplierA 311 may include two unique questions created by ImporterB 312 and a list of baseline questions for the threat category personnel security 603A. The management processing system 210 compiles those two questionnaires into one custom questionnaire that contains one group of baseline questions for personnel security 603A, each of the custom questions from ImporterA 302, and each of the custom questions from ImporterB 312.

In an illustrative embodiment of the present invention, a custom questionnaire may be provided to a particular client utilizing a variety of means of transmission. For example, as illustrated in FIG. 2, a notification may be sent via a communication network informing the client that a questionnaire has been generated. A notification may be transmitted in the form of an e-mail to a particular client utilizing an e-mail address provided by another client or otherwise known to the management processing system 210. Alternatively, a custom questionnaire may be printed in hard copy form and mailed to a client, such as SupplierA 311, for completion and return. For purposes of the discussion of FIGS. 22 and 23, we will utilize the example of the management processing system 210 sending an electronic notification via a communication network to SupplierA 311, indicating that a questionnaire has been generated for its completion. In one embodiment, SupplierA 311 may access the supply-chain processing system 200 utilizing a supplier computing device 204 (FIG. 2).

As illustrated in FIG. 23, upon receipt by the management processing system 210 of a client access, the management processing system 210 identifies the accessing client and transmit the generated custom questionnaire to SupplierA 311 for completion. SupplierA 311, upon completion of the questionnaire, transmits the completed questionnaire to management processing system 210 which associates the completed questionnaire with the client and regenerates the importer questionnaires with the suppliers' completed questions. Additionally, after the management processing system 210 has received the completed client questionnaire, it may notify the providing importers, such as ImporterA 302, that SupplierA 311 has completed its questionnaire. In response, ImporterA 302 may access the management processing system 210 and review the questionnaire it created for that client, with the client's answers included. For example, ImporterA 302 is provided a completed ImporterA questionnaire that includes SupplierA's 204 answers to the questions created by ImporterA 302, and ImporterB 312 would be provided with the completed ImporterB questionnaire that includes SupplierA's 311 answers to the questions created by ImporterB 312. Additionally, each of the questionnaires provided to the importer would include the selected baseline questions for personnel security and the answers provided by the SupplierA 311.

In accordance with an embodiment of the present invention, providing a questionnaire to SupplierA 311 removes the need for SupplierA 311 to complete questionnaires for each of the particular importers. Additionally, requiring the completion of questionnaires for each importer would also require a client to frequently answer the same question more than once. For example, each individual questionnaire would include general basic questions for each of the associated threat categories. However, by compiling each of the importer questionnaires into a single custom questionnaire, duplicate questions may be removed and particular questions may be compiled into one particular questionnaire.

Referring back to FIG. 13A, upon an initial access by a client, such as SupplierA 311, management processing system 210 generates an initial client input screen display 1300 that requests information from the accessing client, such as SupplierA 311. During this initial access communication, master management processing system 210 obtains the same information from a supplier as it would from an importer. For example, if the accessing client is accessing as a supplier, just as it if was an importer, master management processing system may request a client name 1301, an address 1303, a city of location 1305, a state of residence 1307, a country in which the client is located 1309, contact information 1311, whether the client is certified under C-TPAT 1315 and/or PIP 1317, and identify its threat categories. The client may be required to answer specific baseline questions for its identified threat categories. Those questions may be included in the generated questionnaire or provided separately.

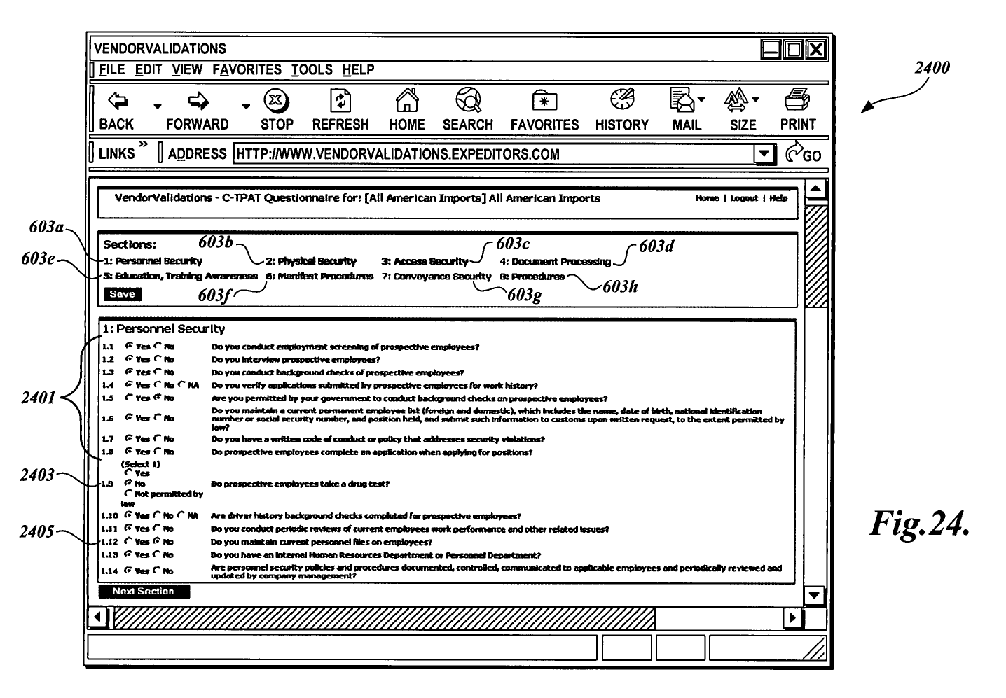

FIG. 24 illustrates a custom questionnaire 2400 generated by management processing system 210, which includes questions 2401, 2403, 2405 organized by threat category 603A, 603B, 603C, 603D, 603E, 603F, 603G, and 603H, according to an embodiment of the present invention. Each of the threat categories of the custom questionnaire 2400 includes the baseline questions for that particular threat category and a compilation of any additional questions and/or created questions that were provided by each importer that identified the particular client as a potential or existing supplier. For example, the first group of questions 2501 are baseline questions that are included for the threat category personnel security 603A. Question 1.9 2503 is a question that was added to the personnel security threat category 603A by ImporterA and Question 1.12 2505 is a question that was created by ImporterB 312 for the surveyed client. A client, in responding to a questionnaire 2500, completes each of the questions in each of the different threat categories by selecting the appropriate answer.

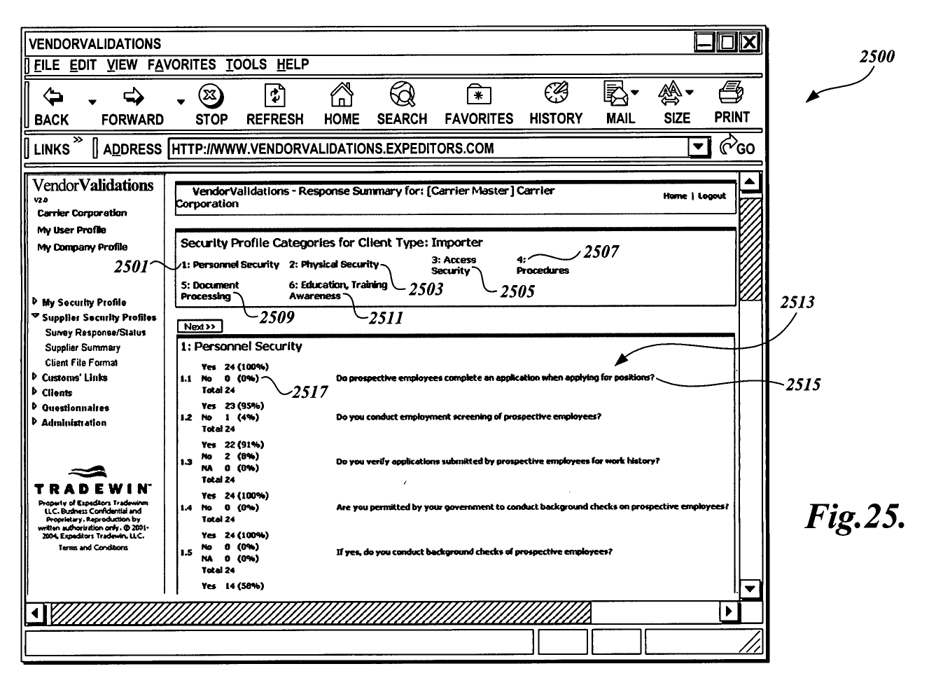

FIG. 25 illustrates a block diagram of a client summary view of importers screen display 2500 for allowing a client to view responses to baseline questions by importers associated with a particular client, according to an embodiment of the present invention. For example, a client may review questions to threat categories, such as threat category personnel security 2501, physical security 2503, access security 2505, procedures 2507, document processing 2509, and education training awareness 2511 for importers that are associated with that client. If a client selects to review responses to baseline questions by its associated importers for the threat category personnel security 2501, upon selection of the personnel security 2501 category the client will be provided with a list 2513 of the baseline questions associated with the threat category personnel security 2501. Along with the list of those questions will be an indication of the number of importers that have answered the questions and what the provided answers are to those questions. For example, a client summary view of the importer screen display 2500 illustrates that the responses to the question “Do prospective employees complete an application when applying for a position?” 2515 has received answers 2517 in the affirmative from 24 associated importers, in the negative from 0 importers, for a total of 24 responding importers.

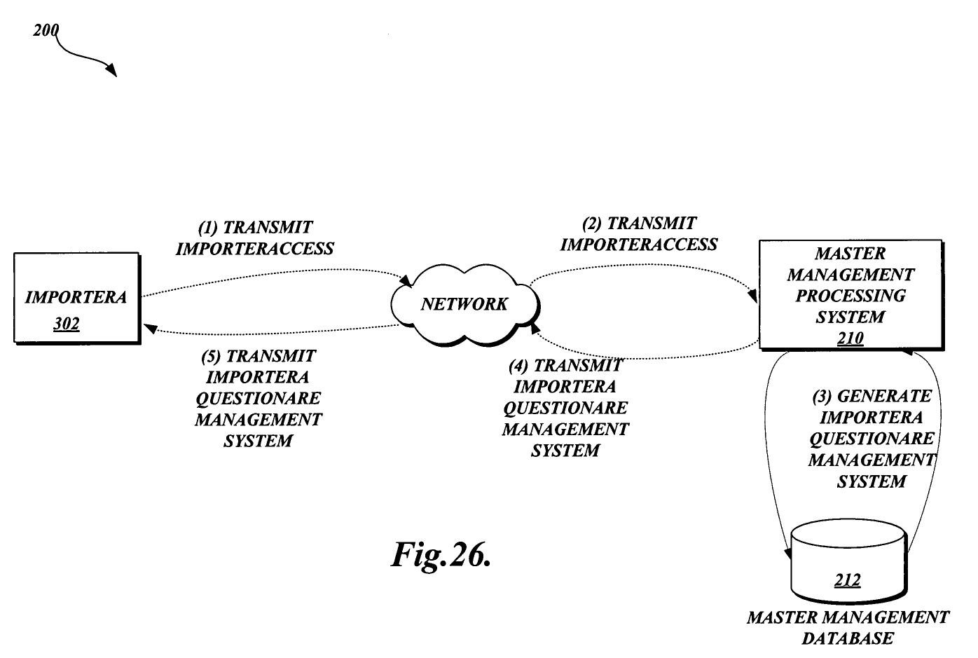

FIG. 26 illustrates a block diagram of a portion of the supply-chain processing system 200 and the interaction of ImporterA 302 with the management processing system 210, according to an embodiment of the present invention. Continuing with the example described in FIG. 23, after completion of a questionnaire by a client, ImporterA 302 again accesses the supply-chain processing system 200 and communicates with the management processing system 210. The management processing system 210, in response to receiving an importer access, identifies the importer, and generates an ImporterA questionnaire management interface. However, in addition to the ImporterA questionnaire management interface generated in the previous description, ImporterA questionnaire management interface will also include a completed questionnaire containing the suppliers' responses. The completed questionnaire includes answers to each of the baseline questions and each of the questions added and/or created by ImporterA 302 and associated with the responding client.

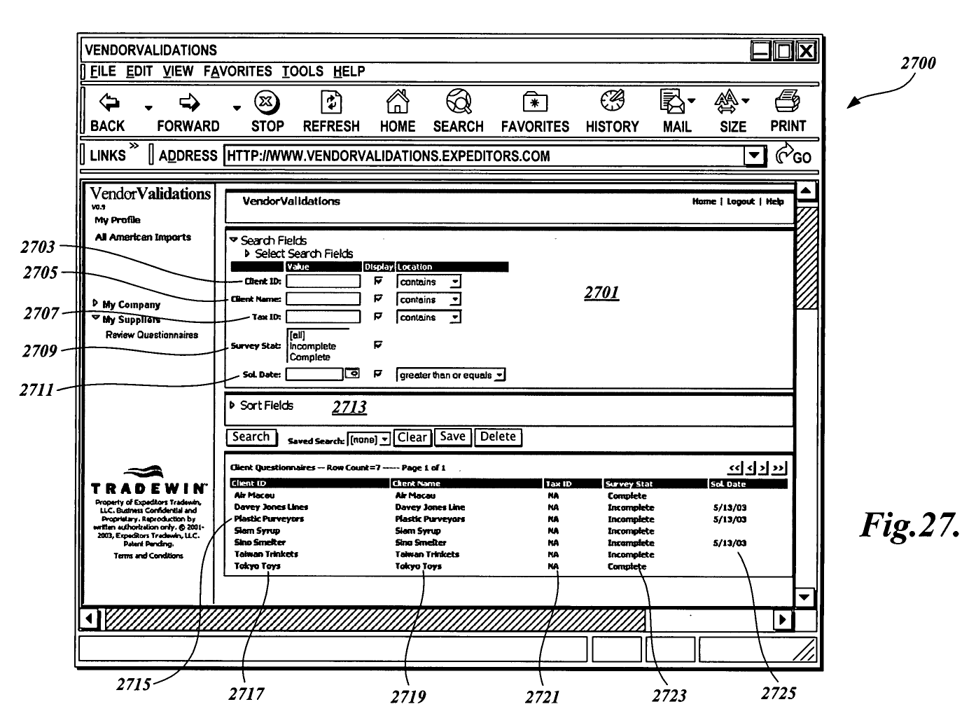

The ImporterA questionnaire management interface provides ImporterA 302 with the ability to review the answers to generated questionnaires, create new questionnaires, identify new suppliers, change its own information, compare responses to multiple questions and questionnaires, etc. For example, FIG. 27 illustrates a questionnaire review screen display 2700 of a questionnaire management interface, in accordance with an embodiment of the present invention. An importer utilizing questionnaire review screen display 2700 may search for a particular client utilizing search field 2701. Additionally, an importer may search by client ID, utilizing client ID search parameter 2703; by client name, using client name search parameter 2705; by a tax ID, utilizing tax ID search parameter 2707; by survey status, utilizing survey status parameter 2709; and/or by solicitation date, utilizing solicitation date search parameter 2711. Still further, questionnaire review screen display 2700 provides an importer with the ability to sort particular search fields by utilizing sort parameter field 2713.

A results field 2715 identifies the results of a search performed utilizing search field parameters 2701. Included in the results field 2715 is a client ID column 2717, a client name column 2719 identifying the name of the client, a tax ID column 2721 identifying the tax ID of the responsive client, a survey status column 2723 identifying the status of any questionnaires, and a solicitation date column 2725 indicating the date the questionnaires were actually sent out to the particular suppliers.

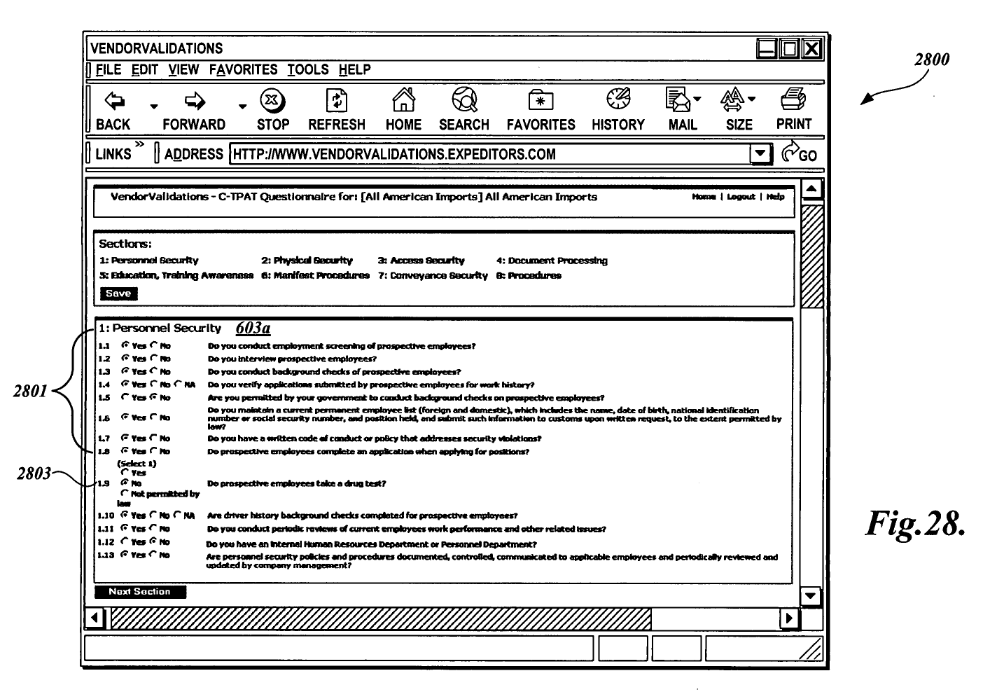

Selection of a client in the response field 2715 generates a status questionnaire screen display 2800, as illustrated in FIG. 28. The completed supplier questionnaire generated in screen display 2800 is the particular questionnaire created by ImporterA for the selected client. For example, the status questionnaire screen display 2800 includes a completed questionnaire generated by ImporterA 302. As can be seen, the baseline questions 2801 for the personnel security 603A threat category are included in the questionnaire 2800, and the ImporterA specific question 2803 is also included in the questionnaire. However, the ImporterB's 312 question that was included in the custom questionnaire 2400 (FIG. 24) issued to the responding client is not included in the status questionnaire screen display 2800. An importer may review client responses, but may not be able to modify those responses.

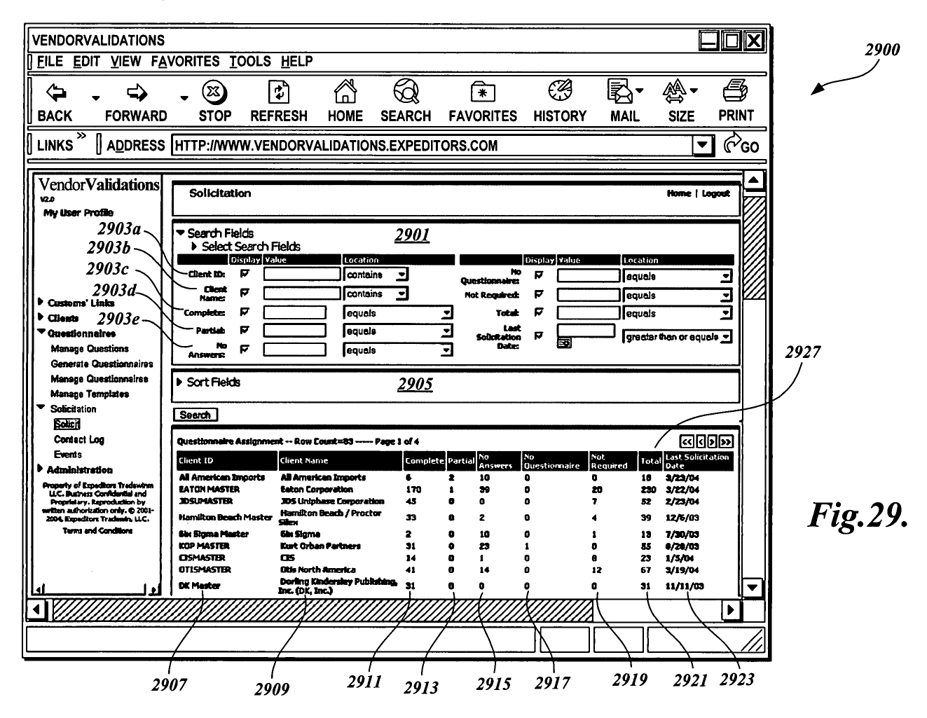

FIG. 29 is a block diagram of a solicitation screen display 2900 of a questionnaire management interface for viewing a client's responses to issued questionnaires, according to an embodiment of the present invention. Solicitation screen display 2900 illustrates the number of completed and partially completed questionnaires. An importer utilizing solicitation screen display 2900 can search for particular suppliers utilizing search parameter fields 2901, including the client ID 2903A, supplier name 2903B, the completion date 2903C, partial completion date 2903D, and a no answers parameter field 2903E. Additionally, an importer may sort responses to the search parameters utilizing sort fields 2905.

The identification of clients matching the search criteria is included in the search fields 2901 generated and displayed in the results display 2927. Included in the results display 2927 is a client ID field 2907, a client name field 2909, a number of questions completed field 2911, a number of questions partially completed field 2913, a number of no answers to questions field 2915, a number of questionnaires fields 2917, a not required field 2919, a total question field 2921, and a last solicitation date field 2923.

The client ID field 2907 identifies the client identification for clients matching the search parameters included in search fields 2901. The supplier name field 2909 identifies the names of the clients matching the search parameters included in search parameter field 2901. The completed questions field 2911 identifies the number of questions that are completed by a particular client. The partially completed field 2913 includes a number of partially completed questions completed by a particular client. The no answers question field 2915 includes a number of questions that have not been answered by a particular client. The total question field 2921 indicates the total number of questions issued to a particular client. The last solicitation date field 2923 identifies the last date that a questionnaire was issued to a particular client. For example, Eaton Master 2925 is the client ID for a client matching the search parameters included in search field 2901. The name of Eaton Master 2925 is Eaton Corporation, and Eaton Corporation has completed 170 questions, partially completed one question, provided no answers to 39 questions, was not required to answer 20 questions, for a total of 230 questions, which were issued in a custom questionnaire on Mar. 22, 2004.

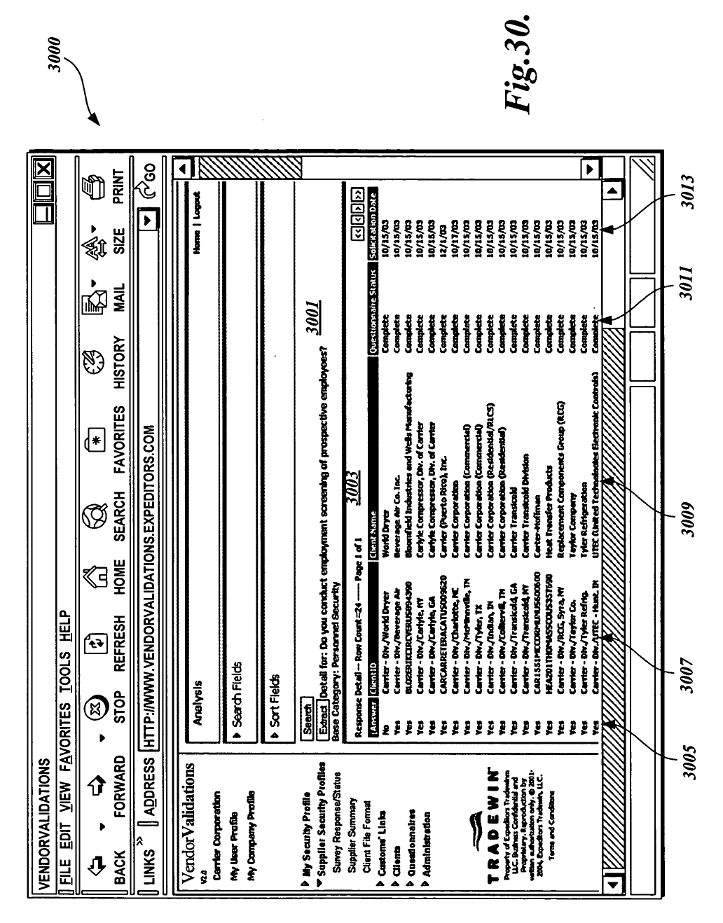

FIG. 30 is a block diagram of a filter screen display 3000 generated by the management processing system 210 for allowing an importer to filter information provided by its associated clients, according to an embodiment of the present invention. An importer, utilizing filter screen display 3000 may filter information provided by its clients in a variety of ways. For example, responses to questions issued to associated clients may be filtered by question type, answer, category type, etc. If an importer selects a particular question, such as “Do you conduct employee screening of prospective employees?” 3001, management processing system 210 generates a list 3003 of answers to that particular question. The list 3003 may illustrate answers 3005 to that question by each associated client identifying the client ID 3007, the client's name 3009, the questionnaire status 3011 from which the particular question was extracted, and the solicitation date 3013 for when that particular questionnaire was issued to the responding client. An importer may utilize this information to, among other things, compare answers to particular questions by its associated clients and/or select particular clients based on their responses, etc.

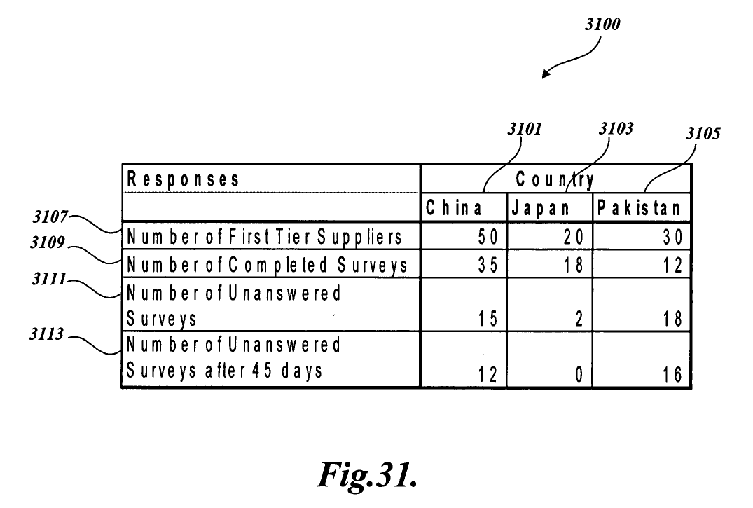

FIG. 31 illustrates a status report screen display 3100 of a questionnaire management interface generated by management processing system 210, according to an embodiment of the present invention. Status report screen display 3100 identifies by country how many questionnaires have been issued and how many remain unanswered. For example, status report survey screen display 3100 identifies three countries, China 3101, Japan 3103, and Pakistan 3105. For each of the identified countries 3101, 3103, and 3105, a number of first tier suppliers 3107 is identified along with a number of completed surveys 3109, a number of unanswered surveys 3111, and a number of surveys that have been unanswered for more than forty-five days 3113. For example, China 3101 has 50 first tier suppliers, 35 completed surveys, 15 unanswered surveys, and 12 surveys that have been unanswered for more than forty-five days. As will be appreciated by one skilled in the relevant art, the status report screen display 3100 is only one example of a status report that may be generated by management processing system 210 and included in a questionnaire management interface, according to an embodiment of the present invention.

For example, a status report screen display could be generated based on category types, which would include each of the different categories described above, the number of first tier suppliers who had been issued surveys containing questions from those categories, the number of the surveys that had been completed, the number of those surveys that remain unanswered, and the number of the surveys that remain unanswered for more than thirty days. Additionally, while only four columns have been included in status report survey 3100 for the number of surveys, the completions, and the uncompleted surveys, it will be appreciated by one skilled in the art that more or fewer informational rows and columns may be included.

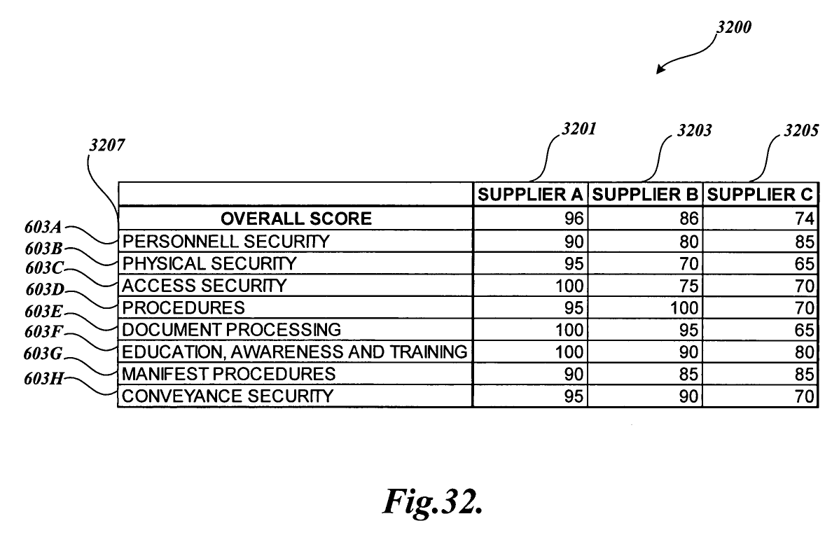

FIG. 32 illustrates a supplier compliance report screen display 3200 that may be included in the importer questionnaire management interface generated by management processing system 210, according to an embodiment of the present invention. Included in the supplier compliance report screen display 3200 is a list of suppliers for a particular importer, such as SupplierA 3201, SupplierB 3203, and SupplierC 3205, their particular scores for each of the eight threat categories 603A, 603B, 603C, 603D, 603E, 603F, 603G, and 603H, and an overall score 3207 for all categories. In accordance with an illustrative embodiment of the present invention, the score may be calculated in a variety of manners. In one embodiment, the score may be generated by a customized mathematical formula. In another embodiment, the score may be a standardized formula applicable to a set of categories. For example, SupplierA 3201 has an overall score of 96, with a score of 90 in the personnel security 603A threat category, a score of 95 in the physical security 603B threat category, a score of 100 in the access security 603C threat category, a score of 95 in the procedures 603D threat category, a score of 100 in the document processing 603E threat category, a score of 100 in the education, awareness and training 603F threat category, a score of 90 in the manifest procedures 603G threat category, and a score of 95 in the conveyance security 603H threat category.

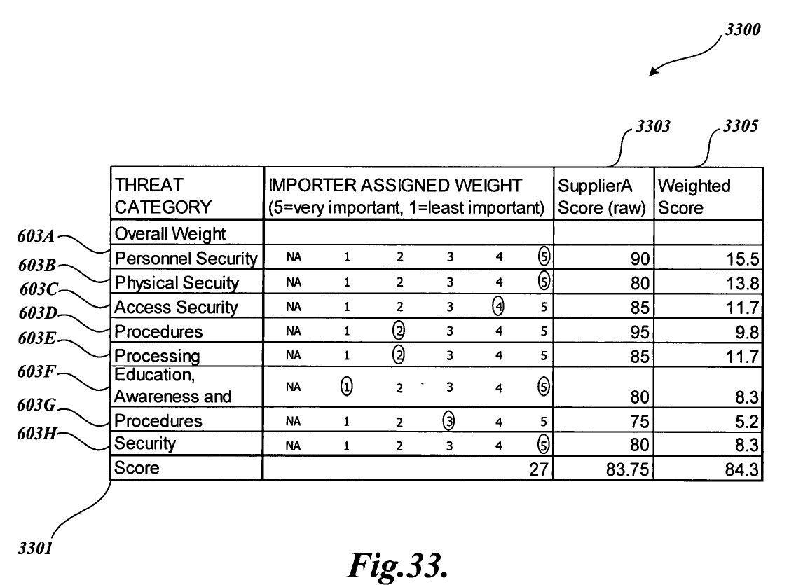

FIG. 33 illustrates a category weighting screen display 3300 of a questionnaire management interface that may be utilized for weighting groups of questions by threat category, according to an embodiment in the present invention. For example, an importer may weight each of the particular threat categories 603A, 603B, 603C, 603D, 603E, 603F, 603G, and 603H on a scale of 1-5 or not applicable, 1 being the least important, 5 being very important. Additionally, a client's, such as SupplierA, raw score may be displayed in supplier raw score column 3303, indicating a raw score for each of the particular categories and an overall score 3301. A raw score is a score of the questions answered by a particular client without applying any weighting to those questions. For example, if a client had answered 75 out of 100 questions in the affirmative and 25 in the negative for the threat category procedures 603G, the raw score would be 75%. A weighted score may be displayed in the weighted score column 3305 for each of the particular categories based on the weighting of the questions of those categories assigned by the importer. A weighted score is a score of the questions answered by a client with the weight of those questions calculated into the score.

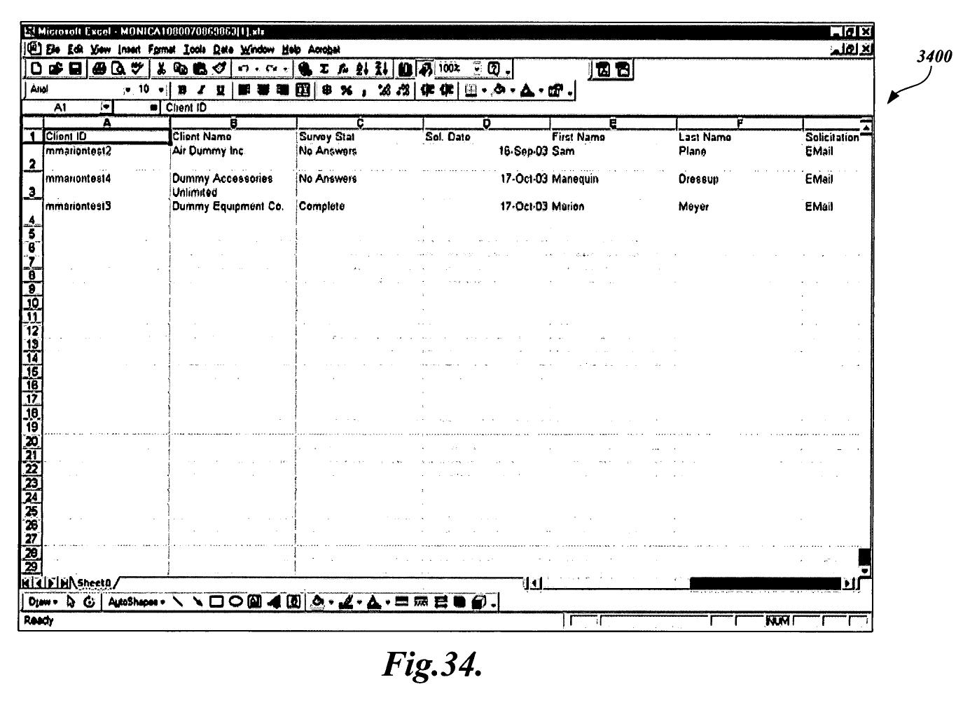

FIG. 34 is a block diagram of a screen display illustrating the results of an extraction routine which may be accomplished utilizing a questionnaire management interface generated by management processing system 210, according to an embodiment of the present invention. All information generated using any of the above-described embodiments may be easily exported and extracted into any type of post-processing system which gives a user more options to use the data in ways that fit their business needs. For example, FIG. 34 illustrates a block diagram of a data export screen display 3400 where information has been exported into Microsoft Excel®, according to an embodiment of the present invention. The information may be exported in a comma delimited, spaced delimited, tab delimited, or any other type of format, or directly into particular third-party applications. As will be appreciated by one skilled in the relevant art, any type of export format may be utilized by embodiments of the present invention for exporting information.

With reference now to FIGS. 35, 36, 37, 38, 39, 40, 41, 42, 43, 44, 45, 46, and 47, a client management routine 3500 implemented by an embodiment of the management processing system 210 and, in particular, by an embodiment of the client management application, will be described. One skilled in the relevant art will appreciate that routine 3500 may be implemented on a single management processing system or distributed to a number of integrated management processing systems. FIGS. 35, 36, 37, 38, 39, 40, 41, 42, 43, 44, 45, 46, and 47 illustrate blocks for performing specific functions. In alternative embodiments, more or fewer blocks may be used. In an embodiment of the present invention, a block may represent a software program, a software object, a software function, a software subroutine, a software method, a software instance, a code fragment, a hardware operation, or a user operation, singly or in combination. For example, in an embodiment of the present invention, the blocks described with respect to FIGS. 35-47 may be implemented within the supply-chain processing system 200 by management processing system 210.

At block 3501 (FIG. 35), a client management routine 3500 begins by a client utilizing a computing device, such as an importer computing device 202 (FIG. 2), and accessing the supply-chain processing system, as illustrated by block 3503. At block 3505, the management processing system 210 determines whether the client accessing the supply-chain processing system 200 is a new client. In an illustrated embodiment of the present invention, the management processing system determines whether the accessing client is new by querying its database for an existing identification of the accessing client. If it is determined at decision block 3505 that the accessing client is new to the supply-chain processing system, control is passed to block 3507 where the management processing system obtains initial client information. As described above with respect to FIGS. 13A, 13B, and 14, the initial information may include, among other items, identification of the client, the location of the client, the threat categories associated with the client (all as shown in FIG. 13A), an identification of suppliers to be associated with the client (FIG. 13B), and the client's responses to baseline questions (FIG. 14).

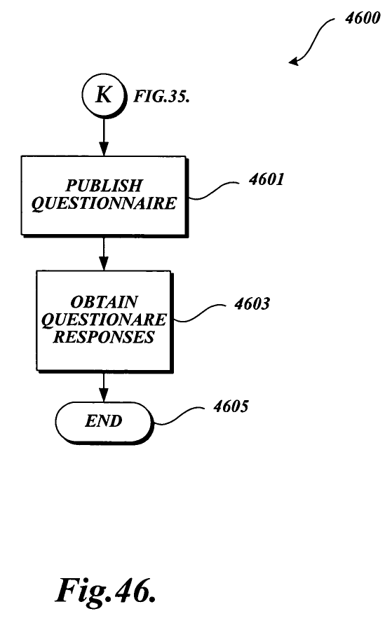

At decision block 3509, a determination is made as to whether the accessing client is accessing the system as an importer. If the client is not accessing the system as an importer, the routine 3500 proceeds to the supplier management routine 4600, as described below with respect to FIG. 46.

At block 3511, if the accessing client is accessing the system as an importer, the management processing system obtains existing importer and supplier information associated with the accessing importer. For example, if the importer had previously accessed the system and generated questionnaires for its suppliers, those questionnaires had been issued to suppliers, and those suppliers had returned responses, those responses and identification of associated suppliers will be obtained by the management processing system.

At block 3513, after the management processing system has either determined that the accessing client is not new to the system or that the accessing client has provided its initial information, the management processing system generates a questionnaire management interface that is specific to the accessing client. In an illustrative embodiment of the present invention, the importer questionnaire management interface generated at block 3511 provides the accessing client with multiple options for generating questionnaires, reviewing responses to already generated and issued questionnaires, and for managing its suppliers.

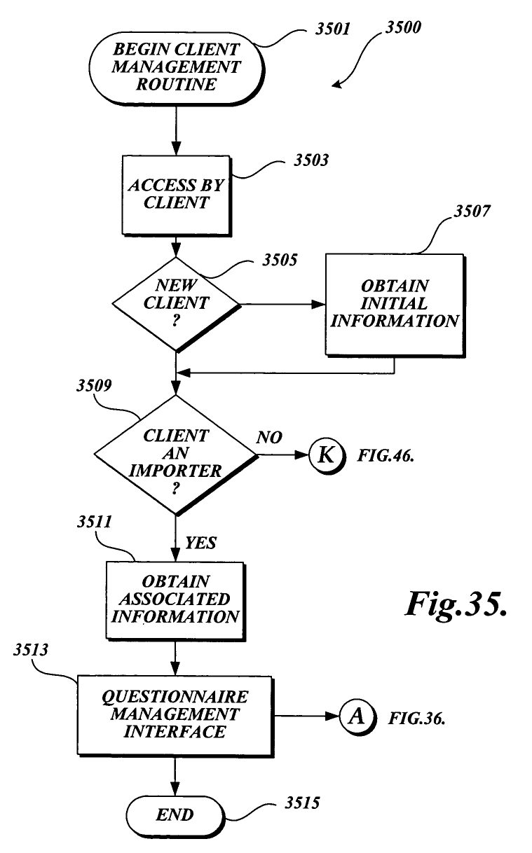

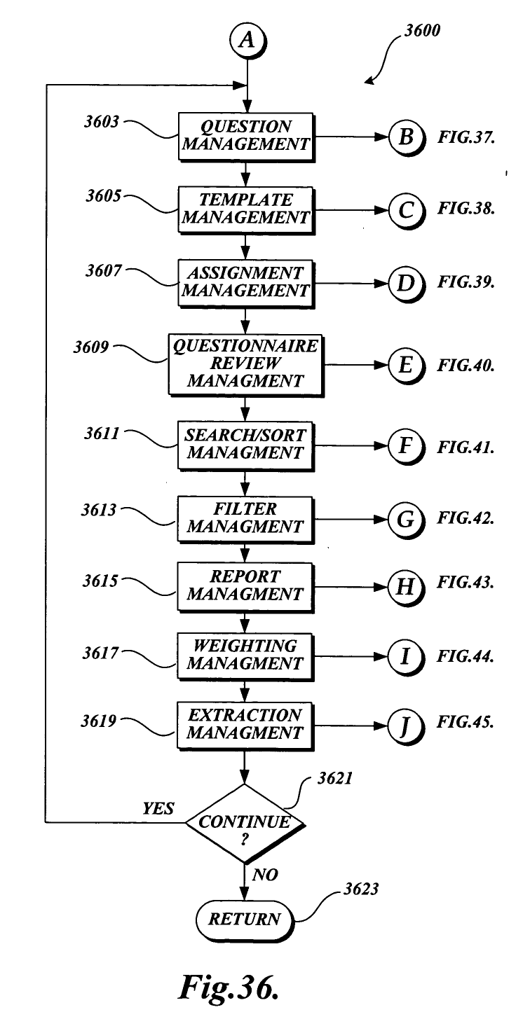

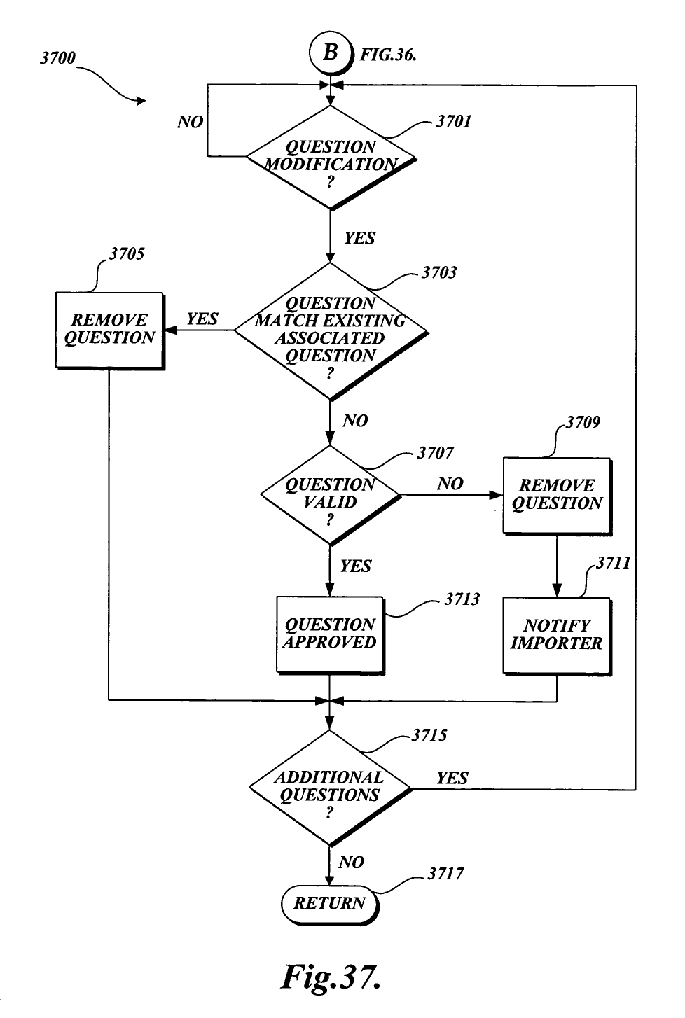

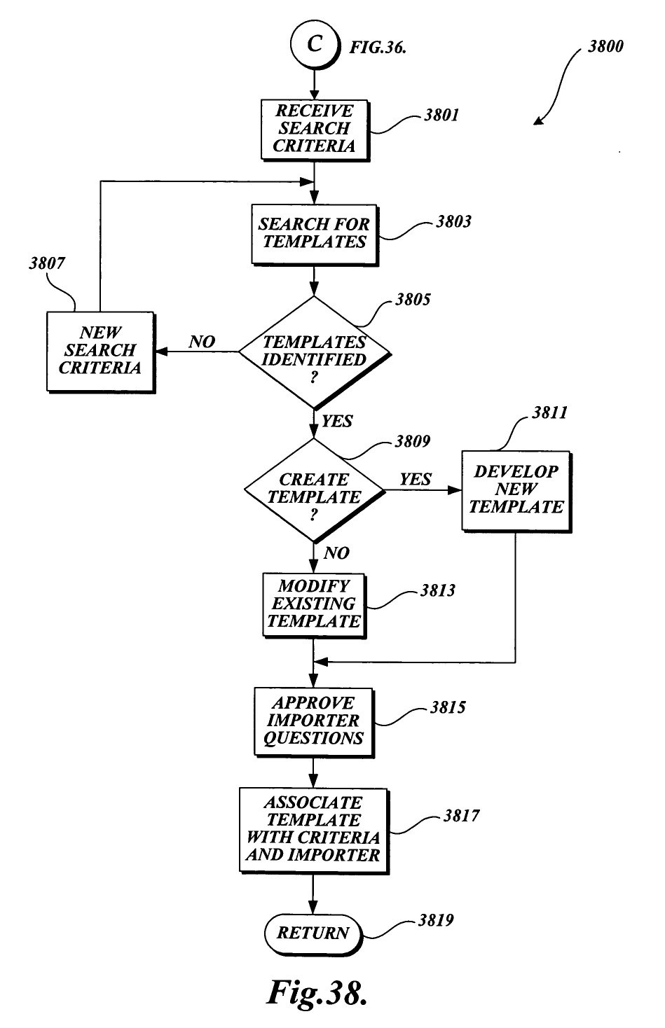

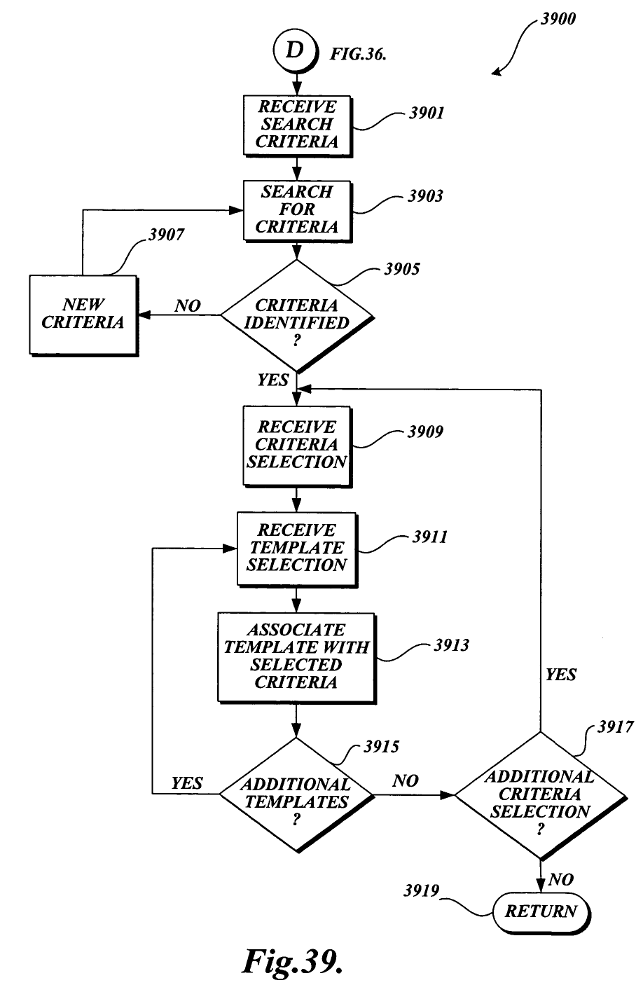

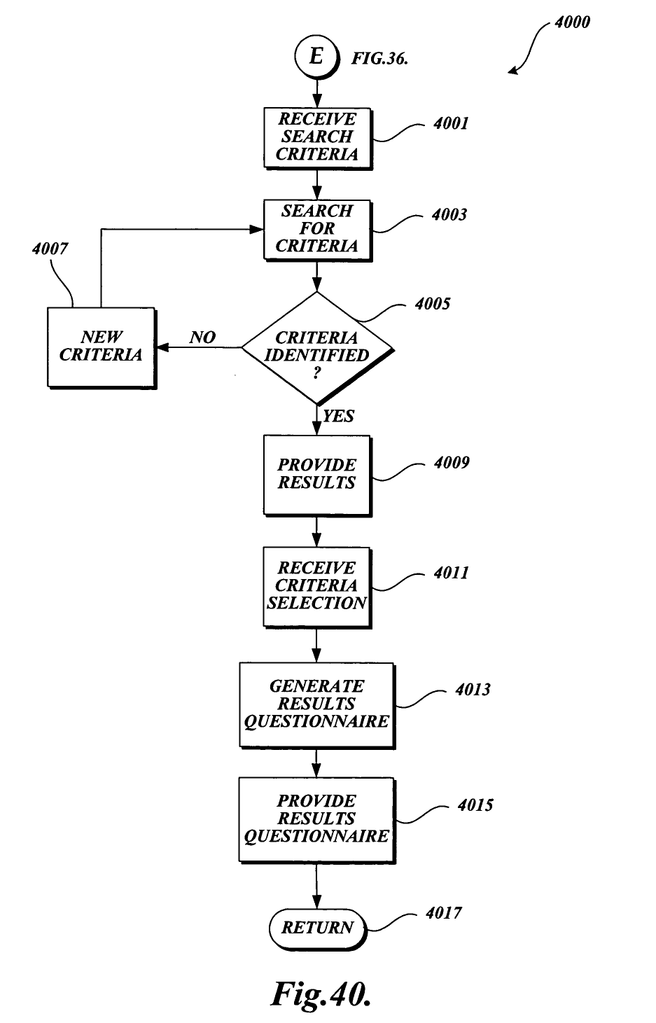

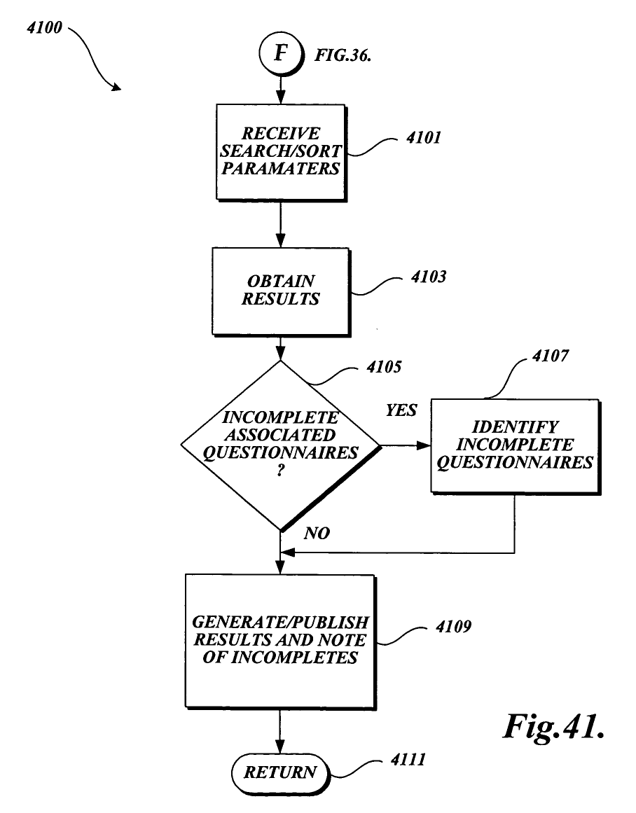

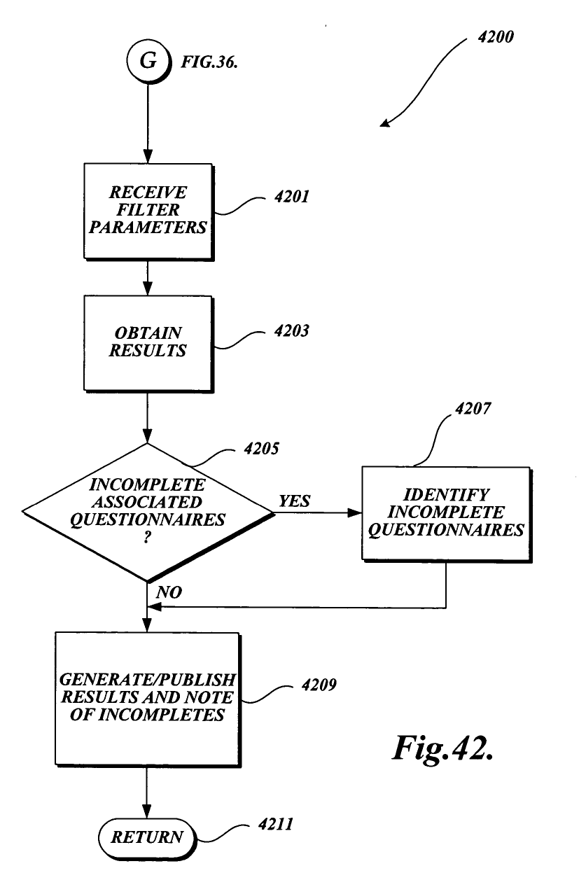

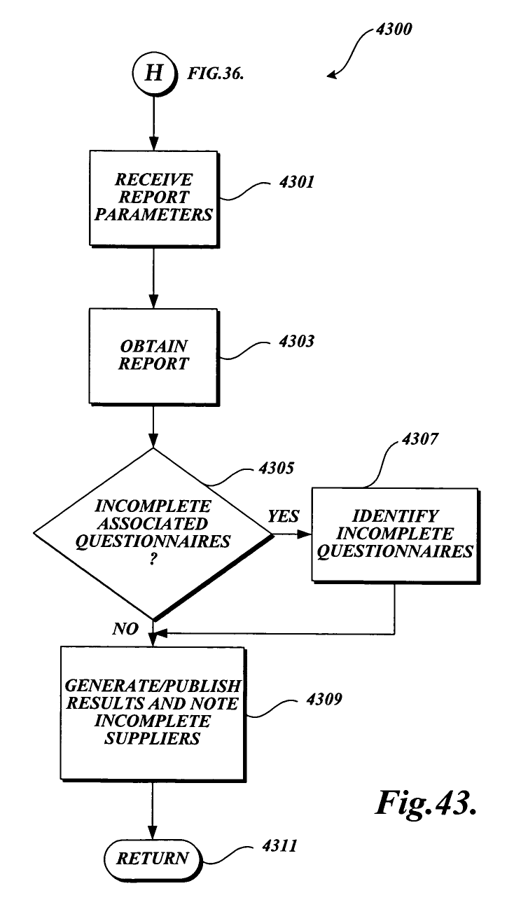

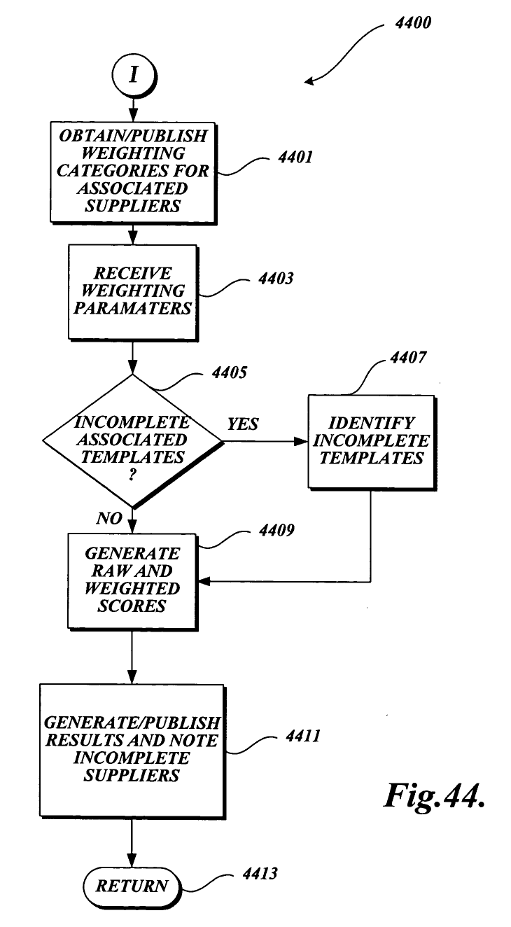

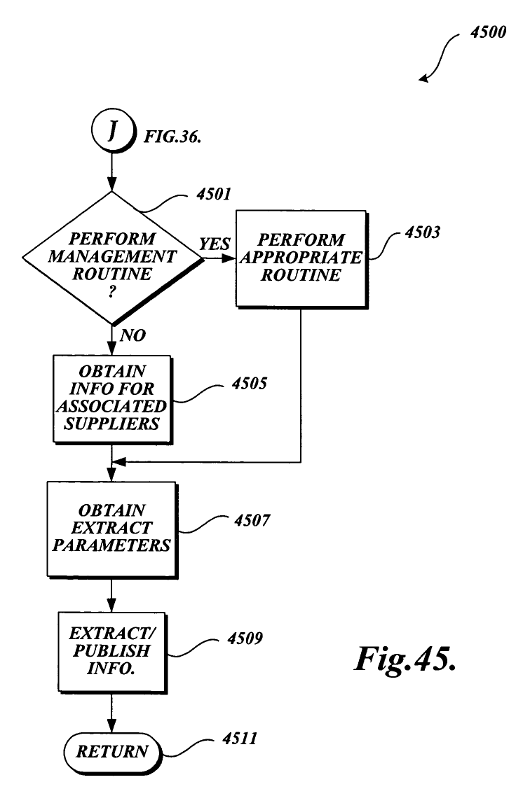

Turning now to FIG. 36, a flow diagram illustrating a routine 3600 for different features that are made available to an accessing client through a generated importer questionnaire management interface, according to an embodiment of the present invention will be described. According to an embodiment of the present invention, there is no limitation to the different features that may be included in a questionnaire management interface, as described with respect to FIG. 36. Additionally, the features may be organized in any way and are not limited to the organization of the flow diagram provided in FIG. 36. For example, the features described with respect to blocks 3603, 3605, 3607, and 3609 may be reorganized into any other organization for importer questionnaire management interface. The arrangement of the features described with respect to blocks 3603, 3605, 3607, 3609, 3611, 3613, 3615, 3617, and 3619 is provided in FIG. 36 for ease of discussion only and is not intended to be limiting in any manner.

As illustrated by blocks 3603, 3605, 3607, 3609, 3611, 3612, 3615, 3617, 3619, an importer utilizing the generated questionnaire management interface may manipulate and view the associated information, manage existing questions, generate new questions, manage templates, assign questions and templates to its clients, review results from issued questionnaires, search and sort the results of issued questionnaires, filter results of issued questionnaires, generate reports representative of issued questionnaires, assign weighting to questions, questionnaires, and categories, and extract data from the supply-chain processing system. Each of these features has been described above, with respect to example screen displays, and the routines for providing these features will be described below with respect to several of the subsequent figures.

Referring first to block 3603, an importer utilizing the generated importer questionnaire management interface may manage questions that are to be generated and issued to a supplier as part of a supplier questionnaire through a question management interface (FIGS. 15, 16, and 17).

Referring to FIG. 37, a flow diagram of a question management routine 3700 of a questionnaire management interface for allowing an importer to utilize the question management interface for managing questions, according to an embodiment of the present invention will be described. Once an importer selects the question management interface 3603 from within a portion of the questionnaire management interface, control is passed to the question management routine 3700 and the management processing system at decision block 3701 determines if a modification to an existing question and/or generation of a new question has been performed by the accessing importer. If, at decision block 3701, it is determined that a question has either been modified and/or a new question has been added, control is passed to decision block 3703 where the management processing system determines whether the modified and/or new question matches existing questions that are associated with the accessing client. If it is determined that the modified and/or new question matches an existing question, control is passed to block 3705 where the management processing system removes the new question from the list of questions associated with the accessing importer, because it already exists.

However, if it is determined in decision block 3703 that the modified and/or new question does not match an existing question associated with the accessing importer, the management processing system determines whether the new and/or modified question is valid, as illustrated by decision block 3707. In an illustrative embodiment of the present invention, the validity of a question may be decided by any known validity-determination technique. For example, a question may be validated by a system that searches for key words that have been identified as not allowable, and/or the system may check for grammatical correctness of the question itself. Alternatively, the validity of the question may be determined by an individual who is notified by the management processing system that a question has been added and/or modified. One skilled in the relevant art will appreciate that any type of question validity technique may be utilized with embodiments of the present invention.

If it is determined at decision block 3707 that the question is not valid, control is passed to block 3709 and the question is removed from the list of questions associated with the accessing importer. The management processing system, in response to removing an invalid question, notifies the accessing importer that the question that has been added and/or modified in the system is not valid and provides the importer with the opportunity to correct the error, as identified at block 3711. Alternatively, if it is determined at block 3707 that the question is valid, the management processing system indicates that the question has been approved and adds it to the list of questions that are associated with the accessing importer, as illustrated by block 3713.

At decision block 3715, the management processing system determines whether there are additional questions that have been added and/or modified. If it is determined at decision block 3715 that additional questions have been added and/or modified, or that the accessing importer remains in the question modification interface, control is returned to decision block 3701 where the management processing system continues the process of validating questions and/or waits for the modification and/or addition of new questions. If, however, the accessing importer does not modify any more questions and leaves the question management interface, control is passed to block 3717 and the questionnaire management routine 3700 completes returning control to the importer questionnaire management routine 3600 (FIG. 36).

Referring again to FIG. 36, block 3605 illustrates that the generated importer questionnaire management interface, generated by the management processing system, may include a template management interface (FIGS. 18 and 19). The template management interface provides an accessing importer with the ability to modify templates of questions. FIG. 38 is a flow diagram of a template management routine 3800 for allowing an accessing importer to utilize the template management interface to manage templates, according to an embodiment of the present invention. At block 3801, the management processing system receives search criteria provided by the accessing importer. In an illustrative embodiment of the present invention, the search criteria may be a request by the importer to search for templates based on threat category, client, supplier, client category, etc.

At block 3803, the management processing system searches for templates matching the criteria provided by the accessing importer. In an embodiment of the present invention, the templates are maintained in the management processing system database, such as management processing system database 212 (FIG. 2). At decision block 3805, the management processing system determines whether templates matching the criteria searched for have been identified. If no templates are identified, the management processing system requests new search criteria from the accessing importer, as illustrated by block 3807. Once the new search criteria has been provided by the accessing importer, control is returned to block 3803, and the process continues.

If, however, it is determined at decision block 3805 that templates have been identified, the templates are obtained by the management processing system and the management processing system determines whether the accessing importer is creating a new template, as illustrated by decision block 3809. If it is determined at decision block 3809 that a new template is being created, the new template is developed, as illustrated by block 3811. As described above with respect to FIGS. 18-19, a template may be created by an accessing importer selecting questions from the list of questions associated with that client, modifying questions, and/or creating new questions.

If it is determined at decision block 3809 that a new template is not being created, the management processing system allows the importer to modify an existing template, as illustrated by block 3813. An existing template may be modified by adding existing questions to the template, adding newly created questions to the template, removing questions from the template, or modifying questions currently associated with the template itself.

At block 3815, the management processing system performs the process of approving questions that have been newly added and/or modified. The process of approving questions is described above with respect to FIG. 37, and that process may be applied here for approving questions that have been added and/or modified to an existing template. Once modified and/or new questions have been approved, the management processing system associates the new and/or modified templates with the criteria searched for and with the client itself, as illustrated by block 3817, and returns control to the questionnaire management routine 3600 (FIG. 36), as illustrated at block 3819.

Returning again to FIG. 36, another feature provided to an accessing importer by the generated questionnaire management interface is an assignment management interface (FIGS. 20 and 21), as illustrated by block 3607. FIG. 39 is a flow diagram of an assignment management routine 3900 for allowing an accessing importer to utilize the assignment management interface to manage the assignment of questions and/or templates to its suppliers, according to an embodiment of the present invention. At block 3901, the management processing system receives an initial search criteria provided by the accessing importer. The search criteria may include client categories, threat categories, suppliers, question types, or any other search criteria for which a client desires to search for information. At block 3903, the management processing system searches for information matching the criteria identified by the accessing importer. If it is determined at decision block 3905 that the criteria has been identified, control is passed to block 3909. If, however, the criteria has not been identified, the management processing system requests new search criteria from the accessing importer, as illustrated by block 3907, returns control to block 3903, and the routine 3900 continues.

At block 3909, the management processing system receives a selection from the accessing importer of one or more of the results provided in response to the search for criteria. For example, the criteria identified by the accessing importer may be a search for its associated suppliers. In such an example, the results identified and returned to the accessing importer is a list of all suppliers associated with that importer. The importer may then select one or more of the identified suppliers, and that selection is received by the management processing system, as illustrated at block 3909.

Upon receipt of a selected criteria, the management processing system receives a selection of a template that is to be associated with the selected criteria, as illustrated by block 3911. In an embodiment of the present invention, an accessing importer may identify one or more templates that are to be associated with the selected criteria, such as one or more of its suppliers. Upon receipt of a template selection, the management processing system associates a selected template with the selected criteria, as illustrated by block 3913. For example, if an accessing client identifies a supplier as the criteria and selects a template, that template is associated with the selected supplier.

At decision block 3915, a determination is made as to whether additional templates have been selected. If additional templates have been selected for the particular criteria, control is returned to block 3911, and the process continues. However, if there are no additional templates that have been identified for the particular criteria selected by the accessing importer, the management processing system determines whether there is an additional criteria selection, as illustrated by decision block 3917. According to an embodiment of the present invention, an additional criteria selection may be an accessing importer selecting another item of the returned search, for example, a different supplier. If it is determined at decision block 3917 that there are no additional criteria selected by the accessing importer, control is returned to the questionnaire management routine 3600 (FIG. 36).

Referring again to FIG. 36, another feature of the generated importer questionnaire management interface, as illustrated by block 3609, is the questionnaire review management interface (FIGS. 27 and 28), according to an embodiment of the present invention. Referring now to FIG. 40, a flow diagram of a questionnaire review management routine 4000 for allowing an accessing importer to utilize the questionnaire review management interface to review its generated questionnaires, according to an embodiment of the present invention, is provided. At block 4001, the management processing system receives search criteria from an accessing client that desires to review questionnaires. According to an embodiment of the present invention, the search criteria may be a supplier, threat category, client category, etc.

Upon receipt of the search criteria, the management processing system searches for questionnaires associated with that importer which match the criteria from within its database, as illustrated by block 4003. At decision block 4005, a determination is made as to whether matching questionnaires have been identified. If no questionnaires have been identified, control is passed to block 4007, and the management processing system requests that the accessing importer provide new search criteria. Upon receipt of a new search criteria, control is returned to block 4003 and the process continues.

If it is determined at decision block 4005 that a questionnaire or questionnaires have been identified, the management processing system obtains the results and provides the results of the search to the accessing importer, as illustrated by block 4009. In an embodiment of the present invention, the results returned to the accessing importer may be, for example, a list of all associated suppliers that have completed questionnaires, a list of associated suppliers that have completed portions of questionnaires, and/or a list of questionnaires. Alternatively, the results returned may be a list of threat categories identifying suppliers associated with those categories that have completed a portion and/or all of a questionnaire.

After the results have been provided, the management processing system at block 4011, receives a selection from an accessing importer of one of the results that was provided at block 4009. Upon receipt of a criteria selection by an accessing importer, the management processing system generates a results questionnaire. For example, if an accessing client has selected a supplier, the questionnaire created by the accessing importer for that particular supplier is generated with the responses provided by the supplier included, as illustrated in block 4013. At block 4015, the generated results questionnaire is provided to the accessing importer. The process of providing an accessing importer with the ability to review questionnaires is completed at block 4017, and control is returned to the importer questionnaire management routine 3600 (FIG. 36).

Referring again to FIG. 36, another feature of the importer questionnaire management interface that is generated and provided to an accessing importer, is the ability for the accessing importer to search and/or sort results provided by suppliers through the use of the solicitation screen display (FIG. 29), as illustrated by block 3611. The routine for providing the solicitation screen display is described with respect to FIG. 41. FIG. 41 is a flow diagram of a search/sort management routine 4100 for allowing an accessing importer to search and/or sort the results of questions, according to an embodiment of the present invention. At block 4101, the management processing system receives the particular search and/or sort parameters requested by the accessing importer. At block 4103, the management processing system obtains the results from its database that match the search/sort parameters provided by the accessing importer. In an embodiment of the present invention, the results obtained from the search/sort parameters may include responses to questionnaires, associated suppliers, threat categories of associated suppliers, supplier categories, etc.

At decision block 4105, the management processing system determines whether the results obtained in block 4103 include incomplete associated questionnaires. If there are incomplete associated questionnaires included in the obtained results, the routine 4100 proceeds to block 4107 where those questionnaires are identified by the management processing system. At block 4109, the management processing system generates and publishes the results of the search/sort parameters and identifies any suppliers who have incomplete questionnaires. At block 4111, control is returned to the importer questionnaire management routine 3600 described with respect to FIG. 36.

As illustrated by block 3613 (FIG. 36), another feature of the importer questionnaire management interface provided to an accessing importer is the ability to filter responses provided by suppliers associated with the accessing importer through the use of a filter management interface (FIG. 30), according to an embodiment of the present invention. FIG. 42 is a flow diagram of a filter management routine 4200 performed by the management processing system for providing the ability for an accessing importer to utilize the filter management interface to filter responses provided by its suppliers, according to an embodiment of the present invention. At block 4201, the management processing system receives the parameters by which the accessing importer desires to have the information filtered. Upon receipt of the filter parameters, the management processing system obtains the results matching the filter parameters from its database, as illustrated at block 4203.

At decision block 4205, the management processing system determines whether there are any incomplete associated questionnaires included in the obtained results. If there are incomplete questionnaires, the management processing system identifies the incomplete questionnaires, as illustrated by block 4207. At block 4209, the management processing system generates and publishes the results matching the filter parameters provided by the accessing importer and identifies any incomplete questionnaires that are responsive to the filter parameters. At block 4211, control is returned to the importer questionnaire management routine 3600 (FIG. 36).

Returning again to FIG. 36, another feature of the generated importer questionnaire management interface is the ability for an accessing importer to generate and manage reports (FIGS. 31 and 32) for information that has been supplied by its associated suppliers, as illustrated by block 3615, the details of which are described with respect to FIG. 43.

FIG. 43 is a flow diagram of a report management routine 4300 for providing the ability for an accessing importer to manage reports on the results provided by its suppliers, according to an embodiment of the present invention. At block 4301, the management processing system receives the parameters for which the report is to be generated from the accessing importer. As illustrated by block 4303, in response to receiving the report parameters from an accessing importer, the management processing system obtains information from its database that matches the report parameters and generates a report matching those parameters.

At decision block 4305, a determination is made by the management processing system as to whether there are any incomplete questionnaires included in the report. If there are incomplete questionnaires, control is passed to block 4307 and the management processing system identifies the incomplete questionnaires. At block 4309, the management processing system generates and publishes the results for the report and identifies any incomplete questionnaires. The report management routine 4300 completes at block 4311 and control is returned to the importer questionnaire management routine 3600.

Another feature of the generated importer questionnaire management interface is the ability for an accessing importer to assign weighting to questions (FIG. 33), as illustrated at block 3617 in FIG. 36, according to an embodiment of the present invention. FIG. 44 is a flow diagram of a weighting management routine 4400 performed by the management processing system for providing an accessing importer with the ability to assign weighting to questions, according to an embodiment of the present invention. At block 4401, the management processing system obtains and publishes the particular weighting categories that are associated with the suppliers of the accessing importer. For example, weighting categories may be for the threat categories associated with a supplier or the client categories. Providing weighting categories allows the accessing importer to assign weighting to those categories based on its own particular preferences and needs. At block 4403, the management processing system receives the weighting parameters assigned to particular categories by the accessing importer.

At decision block 4405, a determination is made as to whether there are any incomplete questionnaires that will be included in the results of the weighting process. If it is determined that there are incomplete questionnaires, control is passed to block 4407 and the management processing system identifies the incomplete questionnaires.

At block 4409, the management processing system generates raw scores and weighted scores for the particular weighting categories. The raw scores generated are the scores for the questions within a category without applying any of the weighting parameters identified by the accessing importer. Additionally, as illustrated by block 4409, the management processing system also generates scores for the categories by the weighted parameters provided by the accessing importer. At block 4411, the management processing system generates and publishes the results of the weighting process, which include the categories, the raw scores, the weighted scores, and an identification of any incomplete questionnaires. At block 4413, the weighting management routine 4400 completes and control is returned to the generated importer questionnaire management routine 3600 described with respect to FIG. 36.

Referring again to FIG. 36, another feature of a questionnaire management interface is the ability for a client to extract information (FIG. 34) from the supply-chain processing system 200, as illustrated by block 3619 and described in detail with respect to FIG. 45.

FIG. 45 is a flow diagram of an extraction management routine 4500 performed by the management processing system for providing an accessing importer the ability to extract information from the supply-chain processing system, according to an embodiment of the present invention. At decision block 4501, the management processing system determines whether the information to be extracted is the total of the information associated with the accessing importer or the results generated in response to one of the other management routines, such as the question management routine 3700, template management routine 3800, assignment management routine 3900, questionnaire review management routine 4000, search/sort management routine 4100, filter management routine 4200, report management routine 4300, or weighting management routine 4400. If it is determined at decision block 4501 that one of the other management routines is to be completed, control is passed to the appropriate routine and that routine is completed as described above, as illustrated by block 4503. If, however, it is determined in decision block 4501 that no other management routine is to be completed, all information associated with the accessing importer is obtained, as illustrated by block 4505.

At block 4507, the particular extraction parameters desired by the accessing importer are obtained. For example, the accessing importer may desire to extract the information to another third-party program, such as word processing, spreadsheet, database, or other type of program. Alternatively, the accessing importer may wish to extract the information into a particular format, such as comma delimited, tab delimited, etc. Upon receipt of the extraction parameters, at block 4509, the management processing system extracts the desired information and provides it to the accessing importer. At block 4511, the process completes and control is returned to the generated importer questionnaire management routine 3600, as described with respect to FIG. 36.

Referring again to FIG. 36, at block 3621, a determination is made as to whether the accessing importer wishes to continue utilizing the generated importer questionnaire management interface. If it is determined that the accessing importer desires to continue use, control is retained by the routine and selection of any one of the management routines described above is permitted. If, however, it is determined that the accessing importer does not wish to continue using the questionnaire management interface, control is passed to block 3623, and the process returns control to the client management routine 3500 which completes at block 3511 (FIG. 35).

FIG. 46 is a flow diagram of a supplier management routine 4600 performed by the management processing system for managing suppliers that are part of the supply-chain processing system, according to an embodiment of the present invention. At block 4601, in response to a determination that the accessing client is not an importer (decision block 3508, FIG. 35), the supplier routine begins and the management processing system publishes a questionnaire (FIG. 24) that is specific to the accessing supplier, as illustrated at block 4601. As described above, the questionnaire published to the accessing supplier is generated from baseline questions that are specific to the threat categories for the particular supplier and from particular questions generated or selected by each of the importers identifying the accessing supplier as a client. The questionnaire may be published electronically using a computing device, such as supplier computing device 204 (FIG. 2) and/or may be published in hard copy and delivered to the supplier.

At block 4603, the management processing system obtains the responses to the questionnaire from the accessing supplier. The responses may be provided electronically or in paper form. The supplier management routine 4600 terminates at block 4605.

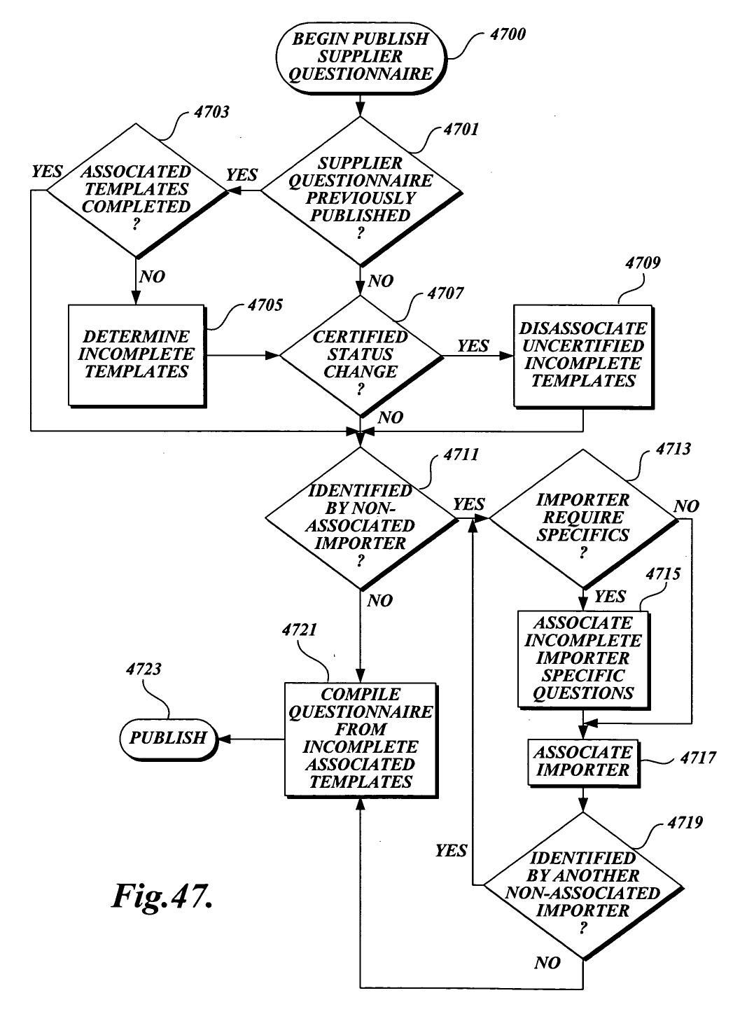

FIG. 47 is a flow diagram of a publish supplier questionnaire routine 4700, according to an embodiment of the present invention. The publish supplier questionnaire routine 4700 provides a detailed description of how the management processing system generates and publishes a supplier questionnaire to a client supplier, as illustrated by block 4601 (FIG. 46) during the supplier management routine 4600.

At decision block 4701, a determination is made by the management processing system as to whether a questionnaire has previously been published to the particular supplier. If the questionnaire has previously been published, the management processing system determines whether the templates associated with the previously published questionnaire have been completed, as illustrated by decision block 4703. If all of the templates in the previously published questionnaire have not been completed, at block 4705, the management processing system determines which templates are incomplete.

However, if no questionnaire has previously been published, or after incomplete templates have been identified, at decision block 4707, a determination as to the certification status of the supplier is performed. In an embodiment of the present invention, a supplier may be certified by one or more entities, thereby allowing the supplier to skip a particular question based on its certificate status. For example, a supplier of an importer may be certified under the PIP, C-TPAT, and/or FAST. If the supplier is certified, it may not be required to complete all of the questions generally compiled for particular threat categories. If it is determined that the supplier's status has changed, and incomplete templates exist if the supplier had previously been issued a questionnaire, at block 4709 the incomplete templates that are no longer required to be completed by that supplier are removed and disassociated from that supplier.

At decision block 4711, the management processing system determines whether the particular supplier has been identified by any non-associated importers. A non-associated importer is an importer that has identified the supplier, but a questionnaire has not yet been generated and published to the supplier for that particular importer. If it is determined at decision block 4711 that there is a non-associated importer identified, control is passed to decision block 4713 and the management processing system determines whether the non-associated importer requires specific questions be answered for the particular supplier or for categories (threat or supplier) associated with that supplier. If it is determined at decision block 4713 that the non-associated importer does require that specific questions be completed by the supplier, at block 4715 the specific questions are associated with that particular supplier. At block 4717, once the importer-specific questions have been associated with the supplier and/or the supplier does not require specific questions be answered, the management processing system associates the previously non-associated importer with a particular supplier.

At decision block 4719, the management processing system determines whether there is another non-associated importer that has identified the supplier. If it is determined at decision block 4719 that there is another non-associated importer, control is returned to block 4713, and the process repeats.

At block 4721, a custom questionnaire containing all incomplete templates associated with a particular supplier and all importer-specific questions associated with that supplier is generated for that supplier, and at block 4723, the compiled custom questionnaire is published to the particular supplier. Publishing the questionnaire may include generating a hard copy of the questionnaire and delivering it to the particular supplier or sending an electronic notice to the supplier that the questionnaire has been generated and/or sending an electronic copy of the questionnaire to the supplier. For example, the management processing system may generate an electronic e-mail message that is delivered to the particular supplier, notifying the supplier that the questionnaire has been completed and alternatively containing an attached copy of the supplier questionnaire or a hyperlink to the questionnaire.

In an alternative embodiment of the present invention, a client that is accessing the system as a supplier that has already completed a previously published questionnaire instead of having a new questionnaire generated and published may be able to access its previously completed questionnaire and continue completion of that questionnaire and/or modify responses to that questionnaire. For example, if a client accessed the supply-chain processing system 200 as a supplier that had previously completed a questionnaire it may, at a later time, reaccess the system, obtain the completed questionnaire, and update answers to those questions.

While illustrative embodiments of the invention have been illustrated and described, it will be appreciated that various changes can be made therein without departing from the spirit and scope of the invention.

1. A method for obtaining information from a client, comprising:
receiving an access request from the client;
generating and transmitting a questionnaire management interface for obtaining an initial set of information about the client, wherein the initial set of information includes identification of a threat category related to the client;
receiving the initial set of information;
in response to receiving the initial set of information, transmitting a set of baseline questions related to the identified threat category and a set of custom questions associated with the client; and
receiving responses to the baseline questions and the custom questions.
